(19) United States
(12) Patent Application Publication
(10) Pub. No.: US 2011/0001741 A1
(43) Pub. Date: Jan. 6, 2011

(54) Display device and electronic apparatus

(75) Inventors: Tetsuro Yamamoto, Kanagawa (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/801,735

(22) Filed: Jun. 23, 2010

(30) Foreign Application Priority Data
Jul. 2, 2009 (JP) 2009-157419

(51) Int. Cl. G09G 5/00

(52) U.S. Cl. 345/211

(57) ABSTRACT

A display device includes: plural pixel circuits; and a scanning circuit that supplies a scanning signal for supplying a video signal including information of a display target video to the plural pixel circuits and transitions potential of the scanning signal to off-potential halfway in a mobility correction period for correcting mobility, wherein each of the plural pixel circuits includes a storage capacitor for storing voltage equivalent to the video signal, a writing transistor that writes the video signal in the storage capacitor on the basis of the scanning signal and changes to a non-conduction state when the off-potential of the scanning signal is supplied, a driving transistor that outputs electric current corresponding to the voltage equivalent to the video signal written in the storage capacitor, and a light emitting element that emits light according to the electric current output from the driving transistor.

### BACKGROUND OF THE INVENTION

1. Field of the Invention

The present invention relates to a display device, and, more particularly to a display device including light emitting elements as pixels and an electronic apparatus including the display device.

2. Description of the Related Art

In recent years, the development of a display device of a surface self-emitting type including organic EL (Electroluminescence) elements as light emitting elements is actively performed. In the display device including the organic EL elements, an electric field applied to an organic thin film is controlled by driving transistors included in pixel circuits. However, the threshold voltage and the mobility of the driving transistors vary in each of the individual driving transistors. Therefore, processing for correcting individual differences of the threshold voltage and the mobility is necessary.

As a display device having a function of correcting mobility of a driving transistor, a display device having a function of correcting, every time light emitting elements are caused to emit light, mobility of a driving transistor on the basis of a video signal including information of a display target video is proposed (see, for example, JP-A-2008-33193 (FIG. 3)). The display device applies potential corresponding to the mobility of the driving transistor to a storage capacitor on the basis of the video signal to thereby correct the mobility of the driving transistor.

### SUMMARY OF THE INVENTION

In the related art explained above, the mobility of the driving transistor can be corrected by reflecting the potential corresponding to the mobility of the driving transistor on the storage capacitor on the basis of the video signal. However, in such a display device, it is necessary to charge parasitic capacitances of the light emitting elements in order to apply the potential corresponding to the mobility of the driving transistor to the storage capacitor. When the parasitic capacitances of the light emitting elements increase, a period for correcting the mobility is extended. Therefore, it is difficult to complete mobility correcting operation within a predetermined time.

Therefore, it is desirable to reduce a period for correcting mobility of a driving transistor that drives organic EL elements.

According to an embodiment of the present invention, there is provided a display device and an electronic apparatus including: plural pixel circuits; and a scanning circuit that supplies a scanning signal for supplying a video signal including information of a display target video to the plural pixel circuits and transitions the potential of the scanning signal to off-potential halfway in a mobility correction period for correcting mobility, wherein each of the plural pixel circuits includes a storage capacitor for storing voltage equivalent to the video signal, a writing transistor that writes the video signal in the storage capacitor on the basis of the scanning signal and changes to a non-conduction state when the off-potential of the scanning signal is supplied, a driving transistor that outputs electric current corresponding to the voltage equivalent to the video signal written in the storage capacitor, and a light emitting element that emits light according to the electric current output from the driving transistor. Consequently, there is an action that the off-potential of the scanning signal is supplied to the pixel circuits halfway in the mobility correction period.

In the embodiment, the scanning circuit may start, when the off-potential is supplied halfway in the mobility correction period, the supply of the off-potential at timing when the voltage written in the storage capacitor is substantially maximized in the mobility correction period. Consequently, there is an action that the supply of the off-potential of the scanning signal is started when the voltage written in the storage capacitor reaches the substantially maximum voltage halfway in the mobility correction period.

In the embodiment, the display device and the electronic apparatus may further include a power supply circuit that supplies, when the off-potential is supplied halfway in the mobility correction period, potential that is high compared with potential during the start of the mobility correction period as power supply potential for the driving transistor. Consequently, there is an action that the power supply potential is raised when the off-potential of the scanning signal halfway in the mobility correction period is supplied.

In the embodiment, the scanning circuit may supply, when the supply of the off-potential of the scanning signal is started halfway in the mobility correction period, the scanning signal having a falling characteristic that is gentle compared with a rising characteristic of the scanning signal during the start of the mobility correction period. Consequently, there is an action that the supply of the off-potential is started by causing the potential of the scanning signal to gently fall halfway in the mobility correction period.

In the embodiment, the scanning circuit may supply, when the off-potential is supplied halfway in the mobility correction period, potential that is high compared with potential supplied when the light emitting element is caused to emit light. Consequently, there is an action that potential that is high compared with the potential supplied when the light emitting element is caused to emit light is supplied as the off-potential of the scanning signal halfway in the mobility correction period.

According to the embodiment of the present invention, an excellent effect can be obtained that a period for correcting mobility of a driving transistor for driving organic EL elements can be reduced.

### BRIEF DESCRIPTION OF THE DRAWINGS

FIG. 1 is a conceptual diagram of a configuration example of a display device according to an embodiment of the present invention;

FIG. 2 is a schematic circuit diagram of a configuration example of a pixel circuit in the display device according to the embodiment;

FIG. 3 is a timing chart concerning a configuration example of the pixel circuit in a first embodiment of the present invention;

FIGS. 4A to 4C are schematic circuit diagrams of operation states of the pixel circuit respectively corresponding to periods TP10, TP1, and TP2;

FIGS. 5A to 5C are schematic circuit diagrams of operation states of the pixel circuit respectively corresponding to periods TP3 to TP5;

FIGS. 6A to 6C are schematic circuit diagrams of operation states of the pixel circuit respectively corresponding to periods TP6 to TP8;

FIG. 7 is a schematic circuit diagram of an operation state of the pixel circuit corresponding to a period TP9;

FIG. 8 is a timing chart for explaining an example of timing for starting a mobility acceleration period in the pixel circuit in a second embodiment of the present invention;

FIG. 9 is a timing chart concerning an operation example of the pixel circuit in the second embodiment;

FIG. 10 is a timing chart concerning potential changes in a first node and a second node in the operation example of the pixel circuit in the second embodiment;

FIG. 11 is a schematic circuit diagram of parasitic capacitances of a writing transistor and a driving transistor in the display device according to an embodiment of the present invention;

FIG. 12 is a timing chart concerning an operation example of the pixel circuit in a third embodiment of the present invention;

FIG. 13 is a timing chart concerning potential changes in the first node and the second node in the operation example of the pixel circuit in the third embodiment;

FIGS. 14A and 14B are diagrams of a configuration example of a write scanner in an operation example of the pixel circuit in a fourth embodiment of the present invention;

FIG. 15 is a timing chart concerning the operation example of the pixel circuit in the fourth embodiment;

FIG. 16 is a timing chart concerning potential changes in the first node and the second node in the operation example of the pixel circuit in the fourth embodiment;

FIGS. 17A and 17B are diagrams for explaining an example of a method of generating a ternarized scanning signal by an output buffer in a fifth embodiment of the present invention;

FIG. 18 is a timing chart concerning an operation example of the pixel circuit in the fifth embodiment;

FIG. 19 is a timing chart concerning potential changes in the first node and the second node in the operation example of the pixel circuit in the fifth embodiment;

FIG. 20 is a diagram of an example of a television set according to a sixth embodiment of the present invention;

FIG. 21 is a diagram of an example of a digital still camera according to the sixth embodiment;

FIG. 22 is a diagram of an example of a notebook personal computer according to the sixth embodiment;

FIG. 23 is a diagram of an example of a portable terminal apparatus according to the sixth embodiment; and

FIG. 24 is a diagram of an example of a video camera according to the sixth embodiment.

### DESCRIPTION OF THE PREFERRED EMBODIMENTS

Modes for carrying out the present invention (hereinafter referred to as embodiments) are explained below. The embodiments are explained in the following order.

1. Configuration example of a display device according to an embodiment of the present invention (display control: an example of the display device)

2. First embodiment of the present invention (display control: an example in which off-potential is supplied halfway in a mobility correction period)

3. Second embodiment of the present invention (display control: an example in which a correction acceleration period is started at timing when inter-node voltage is substantially maximized)

4. Example of parasitic capacitances of a pixel in an embodiment of the present invention (display control: an example of parasitic capacitances of a pixel circuit)

5. Third embodiment of the present invention (display control: an example in which potential of a power supply signal is raised)

6. Fourth embodiment of the present invention (display control: an example in which a falling characteristic is set gentle)

7. Fifth embodiment of the present invention (display control: an example in which high-level non-conduction potential is supplied)

8. Sixth embodiment of the present invention (display control: an example of application to an electronic apparatus)

### 1. Configuration Example of a Display Device According to an Embodiment of the Present Invention

### Configuration Example of the Display Device

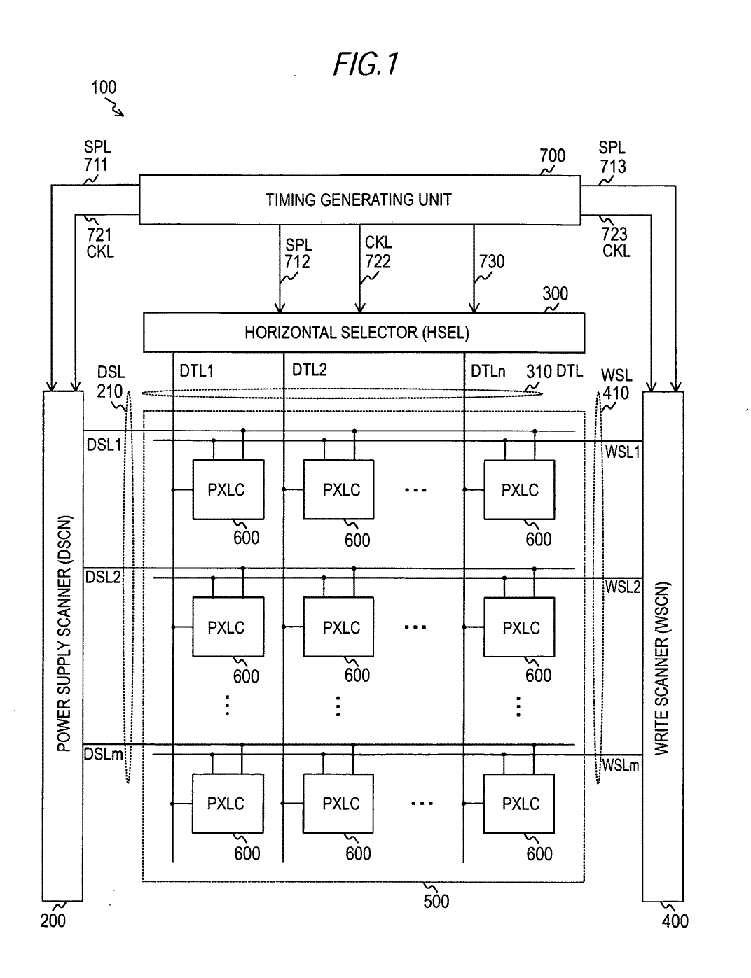

FIG. 1 is a conceptual diagram of a configuration example of a display device 100 according to an embodiment of the present invention. The display device 100 includes a power supply scanner (DSCN: Drive SCaNner) 200 and a horizontal selector (HSEL: Horizontal SELector) 300. The display device 100 further includes a write scanner (WSCN: Write SCaNner) 400, a pixel array unit 500, and a timing generating unit 700. The pixel array unit 500 includes pixel circuits 600 (PXLCs: PiXeL Circuits) 600 arrayed in an n×m two-dimensional matrix shape.

The display device 100 includes a power supply line (DSL: Drive Scan Line) 210 that connects the pixel circuit 600 and the power supply scanner (DSCN) 200. The display device 100 includes a scanning line (WSL: Write Scan Line) 410 that connects the pixel circuits 600 and the write scanner (WSCN) 400. Further, the display device 100 includes a data line (DTL: DaTa Line) 310 that connects the pixel circuits 600 and the horizontal selector (HSEL) 300.

The display device 100 includes a start pulse line (SPL: Start Pulse Line) 711 and a clock pulse line (CKL: ClocK pulse Line) 721 that connect the power supply scanner (DSCN) 200 and the timing generating unit 700. The display device 100 includes a start pulse line (SPL) 712, a clock pulse line (CKL) 722, and a video signal line 730 that connect the horizontal selector (HSEL) 300 and the timing generating unit 700. Further, the display device 100 includes a start pulse line (SPL) 713 and a clock pulse line (CKL) 723 that connect the write scanner (WSCN) 400 and the timing generating unit 700.

The timing generating unit 700 generates, on the basis of a video signal displayed in the pixel circuits 600, a start pulse for starting light emission of the pixel circuits 600 and a clock pulse for synchronizing signals for causing the pixel circuits 600 to emit light. The timing generating unit 700 supplies a start pulse and a clock pulse for the operation of the power supply scanner (DSCN) 200 to the power supply scanner (DSCN) 200 via the start pulse line (SPL) 711 and the clock pulse line (CKL) 721.

The timing generating unit 700 supplies a start pulse and a clock pulse for the operation of the horizontal selector (HSEL) 300 to the horizontal selector (HSEL) 300 via the start pulse line (SPL) 712 and the clock pulse line (CKL) 722. The timing generating unit 700 supplies a video signal to the horizontal selector (HSEL) 300 via the video signal line 730. The timing generating unit 700 supplies a start pulse and a clock pulse for the operation of the write scanner (WSCN) 400 to the write scanner (WSCN) 400 via the start pulse line (SPL) 713 and the clock pulse line (CKL) 723.

The power supply scanner (DSCN) 200 switches power supply potential and initialization potential for initializing the pixel circuits 600 according to line sequential scanning by the write scanner (WSCN) 400 and supplies the potential to the power supply line (DSL) 210 as a power supply signal. The power supply scanner (DSCN) 200 generates the power supply signal on the basis of the start pulse supplied via the start pulse line (SPL) 711. The power supply scanner (DSCN) 200 is an example of a power supply circuit described in the appended claims.

The horizontal selector (HSEL) 300 switches a data signal to one of a reference signal for performing correction of a threshold voltage of driving transistors included in the pixel circuits 600 (threshold correction) and a video signal. The horizontal selector (HSEL) 300 switches the data signal according to the line sequential scanning by the write scanner (WSCN) 400. The horizontal selector (HSEL) 300 generates a data signal on the basis of the start pulse supplied via the start pulse line (SPL) 712. The horizontal selector (HSEL) 300 supplies the generated data signal to the data line (DTL) 310.

The write scanner (WSCN) 400 line-sequentially scans the pixel circuits 600. The write scanner (WSCN) 400 controls, in line units, timing for writing the data signal supplied from the data line (DTL) 310 in the pixel circuits 600. The write scanner (WSCN) 400 generates, on the basis of the start pulse supplied via the start pulse line (SPL) 713, a scanning signal for controlling timing for writing the data signal in the pixel circuits 600. The write scanner (WSCN) 400 supplies the generated scanning signal to the scanning line (WSL) 410. The write scanner (WSCN) 400 is an example of a scanning circuit described in the appended claims.

The pixel circuits (PXLC) 600 hold the potential of a video signal from the data line (DTL) 310 on the basis of the scanning signal from the scanning line (WSL) 410 and emit light for a predetermined period according to the stored potential of the video signal. The pixel circuits (PXLC) 600 are an example of pixel circuits described in the appended claims.

### [Configuration Example of the Pixel Circuit]

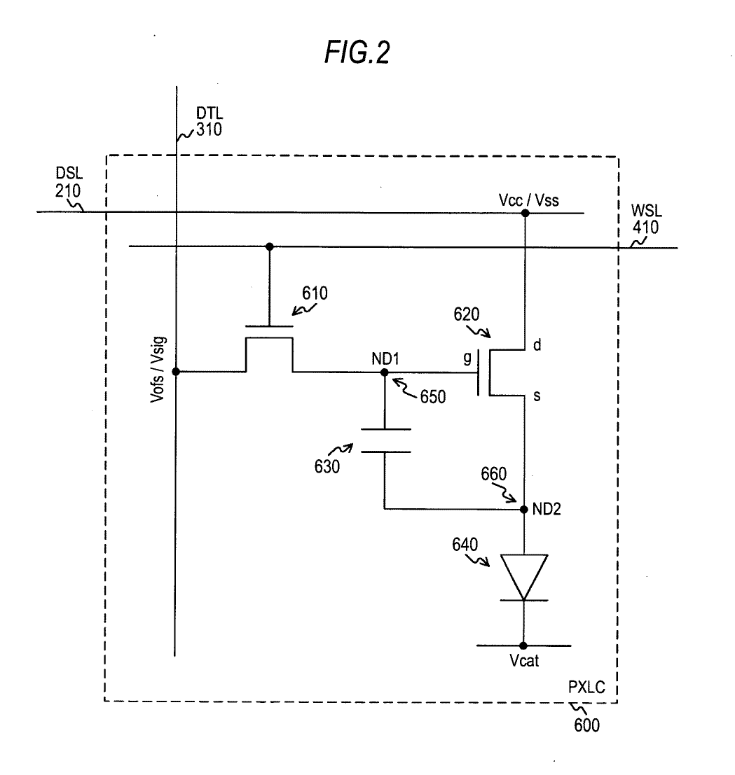

FIG. 2 is a schematic circuit diagram of a configuration example of the pixel circuit (PXLC) 600 in the display device 100 according to this embodiment. The pixel circuit (PXLC) 600 includes a writing transistor 610, a driving transistor 620, a storage capacitor 630, and a light emitting element 640 including an organic EL element. It is assumed that the writing transistor 610 and the driving transistor 620 are respectively n-channel transistors.

The scanning line (WSL) 410 and the data line (DTL) 310 are respectively connected to a gate terminal and a drain terminal of the writing transistor 610. A gate terminal (g) of the driving transistor 620 and one electrode of the storage capacitor 630 are connected to a source terminal of the writing transistor 610. A section of the connection is the first node (ND1) 650. The power supply line (DSL) 210 is connected to a drain terminal (d) of the driving transistor 620. The other electrode of the storage capacitor 630 and an anode electrode of the light emitting element 640 are connected to a source terminal (s) of the driving transistor 620. A section of the connection is the second node (ND2) 660.

The writing transistor 610 writes, according to a scanning signal from the scanning line (WSL) 410, potential (Vofs) of a reference signal for threshold correction or potential (Vsig) of a video signal in the storage capacitor 630 as a data signal from the data line (DTL) 310. The writing transistor 610 writes, after causing the storage capacitor 630 to store a threshold voltage of the driving transistor 620 according to threshold correcting operation, voltage equivalent to the video signal in ND1 as a data signal. The writing transistor 610 is an example of a writing transistor described in the appended claims.

The driving transistor 620 outputs, in a state in which power supply voltage (Vcc) is applied from the power supply line (DSL) 210, driving current based on the voltage stored in the storage capacitor 630 to the light emitting element 640 according to the potential of the video signal. The driving transistor 620 is an example of a driving transistor described in the appended claims.

The storage capacitor 630 stores the voltage equivalent to the data signal written by the writing transistor 610. The storage capacitor 630 is an example of a storage capacitor described in the appended claims.

The light emitting element 640 emits light according to the magnitude of the driving current output from the driving transistor 620. The light emitting element 640 can be realized by, for example, an organic EL element. The light emitting element 640 is an example of a light emitting element described in the appended claims.

In this example, the writing transistor 610 and the driving transistor 620 are respectively the n-channel transistors. However, the n-channel transistors are not limited to this combination. The transistors may be enhancement-type transistors, depression-type transistors, or dual gate-type transistors.

### 2. First Embodiment of the Present Invention

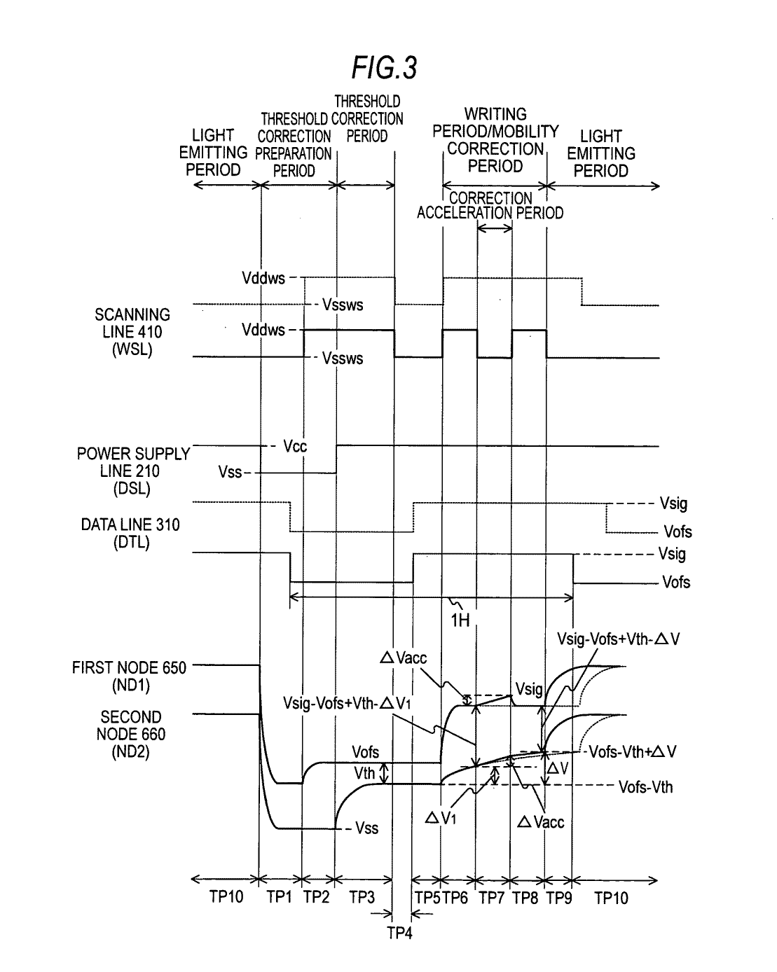

FIG. 3 is a timing chart concerning an operation example of the pixel circuit 600 in a first embodiment of the present invention. With the abscissa set as a common time axis, potential changes in the scanning line (WSL) 410, the power supply line (DSL) 210, the data line (DTL) 310, the first node (ND1) 650, and the second node (ND2) 660 are represented. Concerning the scanning line (WSL) 410, the data line (DTL) 310, the first node (ND1) 650, and the second node (ND2) 660, the potential changes in the first embodiment are indicated by solid lines and potential changes in the related art are indicated by broken lines. Lengths on the abscissa indicating periods are schematic and do not indicate ratios of time lengths of the periods.

In the timing chart, transition of the operation of the pixel circuit 600 in the first embodiment is divided into periods TP1 to TP10 for convenience of illustration. In a light emitting period TP10, the light emitting element 640 is in a light emitting state. Immediately before the end of the light emitting period TP10, the potential of a scanning signal in the scanning line (WSL) 410 is set to non-conduction potential (Vssws) and the potential of a power supply signal in the power supply line (DSL) 210 is set to the power supply potential (Vcc). Thereafter, the operation enters new fields of line sequential scanning. In a threshold correction preparation period TP1, the potential of the power supply line (DSL) 210 is set to an initialization potential (Vss). Consequently, the potentials of the first node (ND1) 650 and the second node (ND2) 660 fall. In the threshold correction preparation period TP1, the potential of the data line (DTL) 310 is set to the potential (Vofs) of the reference signal for the threshold correction. At this point, a horizontal scanning period (1H) as a period for causing the light emitting element 640 in the pixel circuit 600 to emit light is started. The non-conduction potential (Vssws) is an example of off-potential described in the appended claims.

Subsequently, in a threshold correction preparation period TP2, the potential of the scanning line (WSL) 410 is raised to conduction potential (Vddws) and the first node (ND1) 650 is initialized to the potential (Vofs) of the reference signal. According to the initialization, the second node (ND2) 660 is also initialized. The first node (ND1) 650 and the second node (ND2) 660 are initialized in this way, whereby preparation for threshold correcting operation is completed.

In a threshold correction period TP3, threshold voltage correcting operation is performed. The potential of the power supply line (DSL) 210 is set to the power supply potential (Vcc). Voltage equivalent to threshold voltage (Vth) is held between the first node (ND1) 650 and the second node (ND2) 660. Specifically, the potential (Vofs) of the reference signal is applied to the first node (ND1) 650 and reference potential (Vofs−Vth) is applied to the second node (ND2) 660. Consequently, voltage equivalent to the threshold voltage (Vth) is given to the storage capacitor 630. Thereafter, in TP4, the potential of the scanning signal supplied to the scanning line (WSL) 410 is once dropped to the non-conduction potential (Vssws). In TP5, the data signal in the data line (DTL) 310 is switched from the potential (Vofs) of the reference signal to the potential (Vsig) of the video signal.

In a writing period/mobility correction period TP6, the potential of the scanning signal in the scanning line (WSL) 410 is raised to the conduction potential (Vddws) and the potential of the first node (ND1) 650 rises to the potential (Vsig) of the video signal. On the other hand, the potential of the second node (ND2) 660 rises by a first correction amount (ΔV1) with respect to the reference potential (Vofs−Vth). The first correction amount (ΔV1) is a value smaller than a mobility correction amount (ΔV) based on the mobility of the driving transistor 620.

In a correction acceleration period TP7 in the writing period/mobility correction period, the potential of the scanning signal in the scanning line (WSL) 410 is dropped to the non-conduction potential (Vssws) and the potential of the first node (ND1) 650 changes to a floating state. With coupling (boost trap operation) via the storage capacitor 630, the potential of the first node (ND1) 650 rises according to the rise in the potential of the second node (ND2) 660. In this case, speed of the rise in the potential of the second node (ND2) 660 depends on a potential difference between the potential of the first node (ND1) 650 and the potential of the second node (ND2) 660. As the potential difference is larger, the speed of the rise in the potential of the second node (ND2) 660 is higher. Therefore, the speed of the rise in the potential of the second node (ND2) 660 is high compared with the related art indicated by the broken line because the potential of the first node (ND1) 650 is changed to the floating state. In the correction acceleration period TP7, the potential of the second node (ND2) 660 rises by “ΔVacc” with respect to potential (Vofs−Vth+ΔV1) given in TP6. Specifically, the potential of the second node (ND2) 660 rises by a second correction amount (ΔV1+ΔVacc) from the potential given in TP5. The potential of the first node (ND1) 650 rises by “ΔVacc” from the potential (Vsig) of the video signal. The second correction amount (ΔV1+ΔVacc) at the end of TP7 is a value smaller than the mobility correction amount (ΔV).

In a writing period/mobility correction period TP8, the potential of the scanning signal in the scanning line (WSL) 410 is raised to the conduction potential (Vddws) and the potential of the first node (ND1) 650 falls to the potential (Vsig) of the video signal. On the other hand, the potential of the second node (ND2) 660 rises by “ΔV−(ΔV1+ΔVacc)” with respect to potential (Vofs−Vth+ΔV1+ΔVacc) at the end of TP7. Consequently, a rising amount by the mobility correction is “ΔV”. Rising speed of the potential of the second node (ND2) 660 is low compared with the rising speed of the potential in TP7 because a potential difference between the potential of the first node (ND1) 650 and the potential of the second node (ND2) 660 is small compared with the potential difference in TP7. Specifically, since the potential of the scanning signal in the scanning line (WSL) 410 changes to the conduction potential (Vddws) and the writing transistor 610 changes to the conduction state, the potential (Vsig) of the video signal is applied to one electrode of the storage capacitor 630. On the other hand, in the other electrode of the storage capacitor 630, “ΔV−(ΔV1+ΔVacc)” is added to the potential (Vofs−Vth+ΔV1+ΔVacc) given in TP7. Consequently, “Vsig−((Vofs−Vth)+ΔV)” is stored in the storage capacitor 630 as potential equivalent to the video signal.

Thereafter, in light emitting periods TP9 and TP10, the potential of the scanning signal in the scanning line (WSL) 410 is set to the non-conduction potential (Vssws). Thereafter, the data line (DTL) 310 is set to the potential (Vofs) of the reference signal. Consequently, the light emitting element 640 emits light at luminance corresponding to voltage (Visg−Vofs+Vth−ΔV) given to the storage capacitor 630. In this case, the voltage (Visg−Vofs+Vth−ΔV) given to the storage capacitor 630 is adjusted by threshold voltage (Vth) and the voltage (ΔV) for the mobility correction. Therefore, the luminance of the light emitting element 640 is not affected by fluctuation in the threshold voltage (Vth) and the mobility of the driving transistor 620. In a period from TP9 and halfway in TP10 in the light emitting period, the potentials of the first node (ND1) 650 and the second node (ND2) 660 rise. At this point, the potential difference (Visg−Vofs+Vth−ΔV) between the first node (ND1) 650 and the second node (ND2) 660 is maintained by the boost trap operation. The horizontal scanning period (1H) ends when the light emitting period TP9 ends. The next horizontal scanning period is started.

On the other hand, in a writing period/mobility correction period in the related art indicated by the broken line, the potential of the scanning signal in the scanning line (WSL) 410 is raised to the conduction potential (Vddws) when this period begins. The potential is dropped to the non-conduction potential (Vssws) when the period ends. Specifically, in the writing period/mobility correction period of the related art, since only the conduction potential (Vddws) of the scanning signal in the scanning line (WSL) 410 is supplied and the non-conduction potential (Vssws) is not supplied, there is no correction acceleration period. In the related art, since the correction acceleration period is not set, speed of the rise in the potential of the second node (ND2) 660 gradually falls when the potential of the first node (ND1) 650 is about to reach the potential (Vsig) of the video signal. This is because the speed of the rise in the potential of the second node (ND2) 660 depends on a potential difference between the first node (ND1) 650 and the second node (ND2) 660.

On the other hand, in the writing period/mobility correction period in this embodiment, the non-conduction potential (Vssws) of the scanning line (WSL) 410 is supplied halfway in the writing period/mobility correction period TP6 to TP8, whereby the correction acceleration period is set. Consequently, in the writing period/mobility correction period in this embodiment, it is possible to reduce the mobility correction period by increasing the rising speed of the potential of the second node (ND2) 660.

### [Transition of the Operation of the Pixel Circuit]

Transition of the operation of the pixel circuit 600 in the first embodiment is explained in detail below with reference to the drawings. An operation state of the pixel circuit 600 corresponding to the period TP1 to TP10 of the timing chart shown in FIG. 3 is explained. For convenience of illustration, parasitic capacitance 641 of the light emitting element 640 is shown. The writing transistor 610 is shown as a switch. The scanning line (WSL) 410 is not shown.

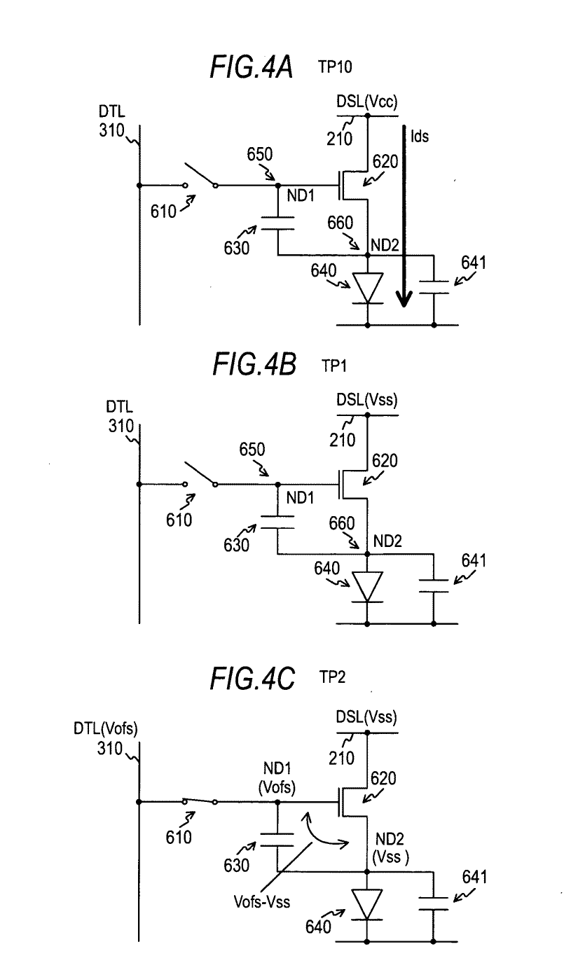

FIGS. 4A to 4C are schematic circuit diagrams of operation states of the pixel circuit 600 respectively corresponding to the periods TP10, TP1, and TP2. In the light emitting period TP10, as shown in FIG. 4A, the potential of the power supply line (DSL) 210 is in a state of the power supply potential (Vcc). The driving transistor 620 supplies driving current (Ids) to the light emitting element 640.

In the threshold correction preparation period TP1, as shown in FIG. 4B, the potential of the power supply line (DSL) 210 transitions from the power supply potential (Vcc) to the initial potential (Vss). Consequently, since the potential of the second node (ND2) 660 falls, the light emitting element 640 changes to a non-light emitting state. The potential of the first node (ND1) 650 in the floating state falls following the potential fall of the second node (ND2) 660.

Subsequently, in the threshold correction preparation period TP2, as shown in FIG. 4C, the potential of the scanning line (WSL) 410 transitions to the conduction potential (Vddws), whereby the writing transistor 610 changes to an ON (conduction) state. Consequently, the potential of the first node (ND1) 650 is initialized to the potential (Vofs) of the reference signal in the data line (DTL) 310. On the other hand, if the initialization potential (Vss) of the power supply line (DSL) 210 is sufficiently lower than the potential (Vofs) of the reference signal, the potential of the second node (ND2) 660 is initialized to the initialization potential (Vss) of the power supply line (DSL) 210. The initialization potential (Vss) of the power supply line (DSL) 210 is set such that a potential difference (Vofs−Vss) between the first node (ND1) 650 and the second node (ND2) 660 is larger than the threshold voltage (Vth) of the driving transistor 620.

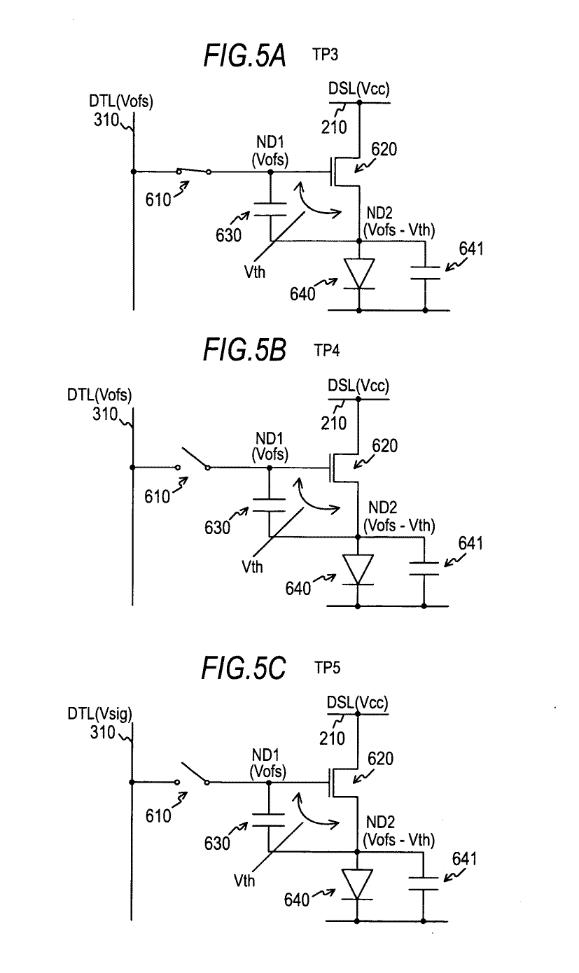

FIGS. 5A to 5C are schematic circuit diagrams of operation states of the pixel circuit 600 respectively corresponding to the periods TP3 to TP5.

Following TP2, in the threshold correction period TP3, as shown in FIG. 5A, the potential of the power supply line (DSL) 210 transitions to the power supply potential (Vcc). Consequently, since electric current flows to the driving transistor 620, the potential of the second node (ND2) 660 rises. After a fixed time elapses, the potential difference between the first node (ND1) 650 and the second node (ND2) 660 changes to a potential difference equivalent to the threshold voltage (Vth). In this way, voltage equivalent to the threshold voltage (Vth) of the driving transistor 620 is given to the storage capacitor 630. This is threshold voltage correcting operation. At this point, values of the potential of a cathode electrode of the light emitting element 640 and the reference potential (Vofs) are set such that electric current does not flow from the driving transistor 620 to the light emitting element 640. Consequently, the electric current of the driving transistor 620 flows to the storage capacitor 630.

In TP4, as shown in FIG. 5B, the potential of the scanning signal supplied from the scanning line (WSL) 410 transitions to the non-conduction potential (Vssws) and the writing transistor 610 changes to an OFF (non-conduction) state. Subsequently, in TP5, as shown in FIG. 5C, the potential of the data signal in the data line (DTL) 310 transitions from the potential (Vofs) of the reference signal to the potential (Vsig) of the video signal. In this case, in the data line (DTL) 310, the writing transistors 610 in the plural pixel circuits 600 connected to the data line (DTL) 310 change to diffusion capacitors. Therefore, the potential (Vsig) of the video signal gently rises. With a transient characteristic of the data line (DTL) 310 taken into account, the writing transistor 610 is set in the OFF state until the data signal reaches the potential (Vsig) of the video signal.

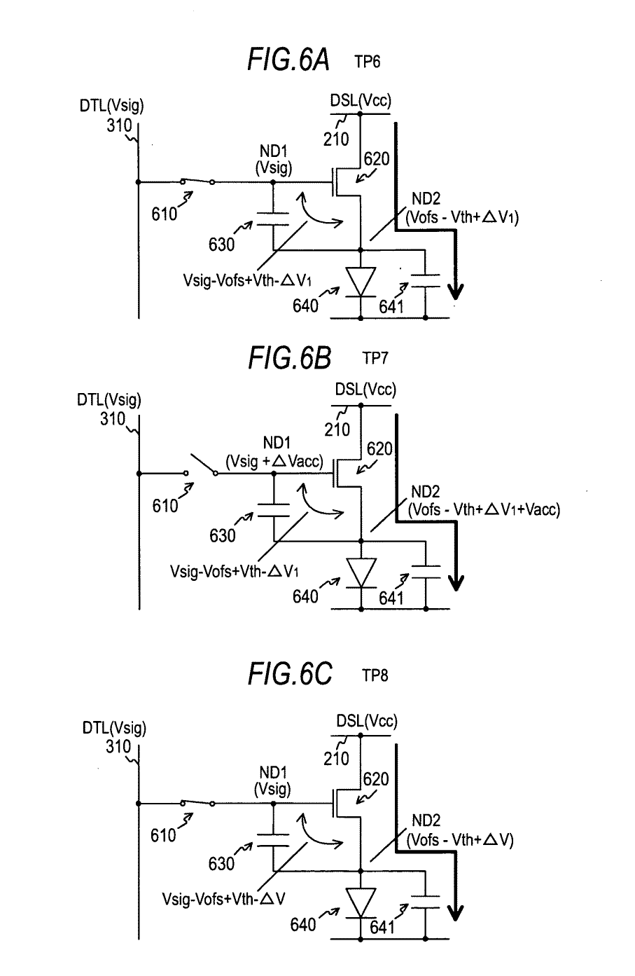

FIGS. 6A to 6C are schematic circuit diagrams of operation states of the pixel circuit 600 respectively corresponding to the periods TP6 and TP8.

Following TP5, in the writing period/mobility correction period TP6, as shown in FIG. 6A, the potential of the scanning signal in the scanning line (WSL) 410 transitions to the conduction potential (Vddws) and the writing transistor 610 changes to the ON state. Consequently, the potential of the first node (ND1) 650 is set to the potential (Vsig) of the video signal. At the same time, electric current flows from the driving transistor 620 to the parasitic capacitance 641 of the light emitting element 640. Therefore, charging of the parasitic capacitance 641 is started and the potential of the second node (ND2) 660 rises by the first correction amount (ΔV1) with respect to the reference potential (Vofs−Vth). The potential difference between the first node (ND1) 650 and the second node (ND2) 660 changes to “Vsig−Vofs+Vth−ΔV1”.

In the correction acceleration period TP7, as shown in FIG. 6B, the potential of the scanning signal supplied from the scanning line (WSL) 410 transitions to the non-conduction potential (Vssws) and the writing transistor 610 changes to the OFF (non-conduction) state. Consequently, the potential of the first node (ND1) 650 changes to the floating state. The potential of the second node (ND2) 660 rises at rising speed corresponding to the potential difference between the first node (ND1) 650 and the second node (ND2) 660 at a point when the potential of the first node (ND1) 650 changes to the floating state. With the coupling (the boost trap operation) via the storage capacitor 630, the potential of the first node (ND1) 650 rises according to the rise in the potential of the second node (ND2) 660. Rising speed of the potential of the second node (ND2) 660 in TP7 depends on the potential difference (Vsig−Vofs+Vth−ΔV1) between the first node (ND1) 650 and the second node (ND2) 660. Specifically, speed of rise (ΔVacc) of the potential of the second node (ND2) 660 is higher as the potential difference between the first node (ND1) 650 and the second node (ND2) 660 is larger. The potential of the second node (ND2) 660 rises by the second correction amount (ΔV1+ΔVacc) with respect to the reference potential (Vofs−Vth). Specifically, rise to target potential (Vofs−Vth+ΔV) is accelerated. In TP7, the potential difference (Vsig−Vofs+Vth−ΔV1) between the first node (ND1) 650 and the second node (ND2) 660 is maintained.

Following TP7, in the writing period/mobility correction period TP8, as shown in FIG. 6C, the writing transistor 610 changes to the ON state and the potential of the first node (ND1) 650 changes to the potential (Vsig) of the video signal. Consequently, electric current flows from the driving transistor 620 to the parasitic capacitance 641 of the light emitting element 640 and the parasitic capacitance 641 is charged. Therefore, the potential of the second node (ND2) 660 rises. The potential difference between the first node (ND1) 650 and the second node (ND2) 660 changes to “Vsig−Vofs+Vth−ΔV1”. In this way, writing of the potential (Vsig) of the video signal and adjustment of the rising amount (ΔV) by the mobility correction are performed.

In this case, since the electric current from the driving transistor is larger as the potential (Vsig) of the video signal is higher, the rising amount (ΔV) by the mobility correction is also large. Therefore, it is possible to perform mobility correction corresponding to a luminance level (the potential of the video signal). When the potential (Vsig) of the video signal for each of pixel circuits is fixed, the rising amount (ΔV) by the mobility correction is larger in the pixel circuit having lager mobility of the driving transistor. Specifically, in the pixel circuit having large mobility of the driving transistor, since electric current from the driving transistor is large compared with that in the pixel circuit having small mobility, a gate-to-source voltage of the driving transistor is small. Therefore, in the pixel circuit having the large mobility of the driving transistor, the electric current from the driving transistor is adjusted to magnitude same as that of the pixel circuit having the small mobility. In this way, fluctuation in the mobility of the driving transistor in each of the pixel circuits is eliminated.

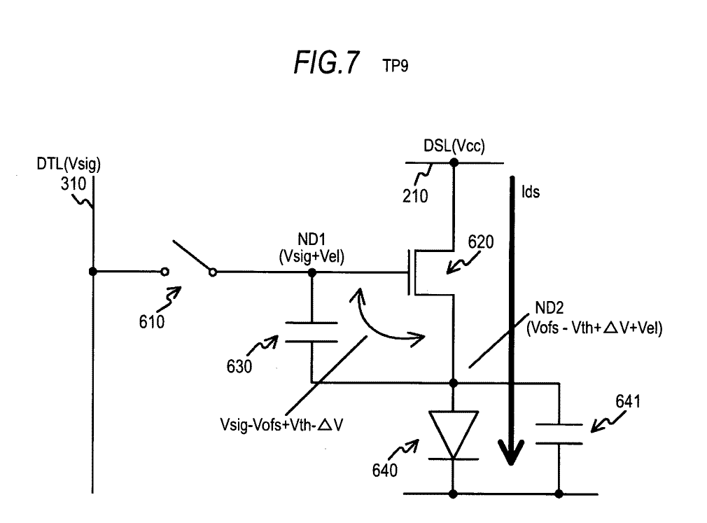

FIG. 7 is a schematic circuit diagram of an operation state of the pixel circuit 600 corresponding to the period TP9.

In the light emitting period TP9, as shown in FIG. 7, the writing transistor 610 changes to the OFF state. In TP8, the data signal in the data line (DTL) 310 is switched to the reference signal (Vofs). Consequently, the potential of the second node (ND2) 660 rises according to the driving current (Ids) of the driving transistor 620 and the potential of the first node (ND1) 650 also rises in association with the rise in the potential of the second node (ND2) 660. At this point, the potential difference (Vsig−Vofs+Vth−ΔV) between the first node (ND1) 650 and the second node (ND2) 660 is maintained by the boost trap operation. The period TP9 is a period provided such that the data signal in the data line (DTL) 310 is not switched to the reference signal before the writing transistor 610 changes to the OFF state.

In this way, the non-conduction potential (Vssws) of the scanning signal in the scanning line (WSL) 410 is supplied halfway in the writing period/mobility correction period TP6 to TP8. This makes it possible to provide a correction acceleration period for reducing a period of the mobility correction.

In the example explained above, the number of times of the correction acceleration period TP7 is one. However, the number of times of the correction acceleration period TP7 is not limited to this. For example, the mobility correction may be performed by repeating variation of the potential of the scanning signal in the scanning line (WSL) 410 plural times to provide plural correction acceleration periods TP7.

In the example explained above, the writing period/mobility correction period in the pixel circuit 600 including two transistors is reduced. However, this embodiment can be applied to any pixel circuit as long as the pixel circuit has a period for correcting the mobility of a driving transistor. For example, a pixel circuit including plural transistors besides the two transistors is conceivable.

A potential difference between the first node (ND1) 650 and the second node (ND2) 660 in the writing period/mobility correction period is explained below with reference to the drawings.

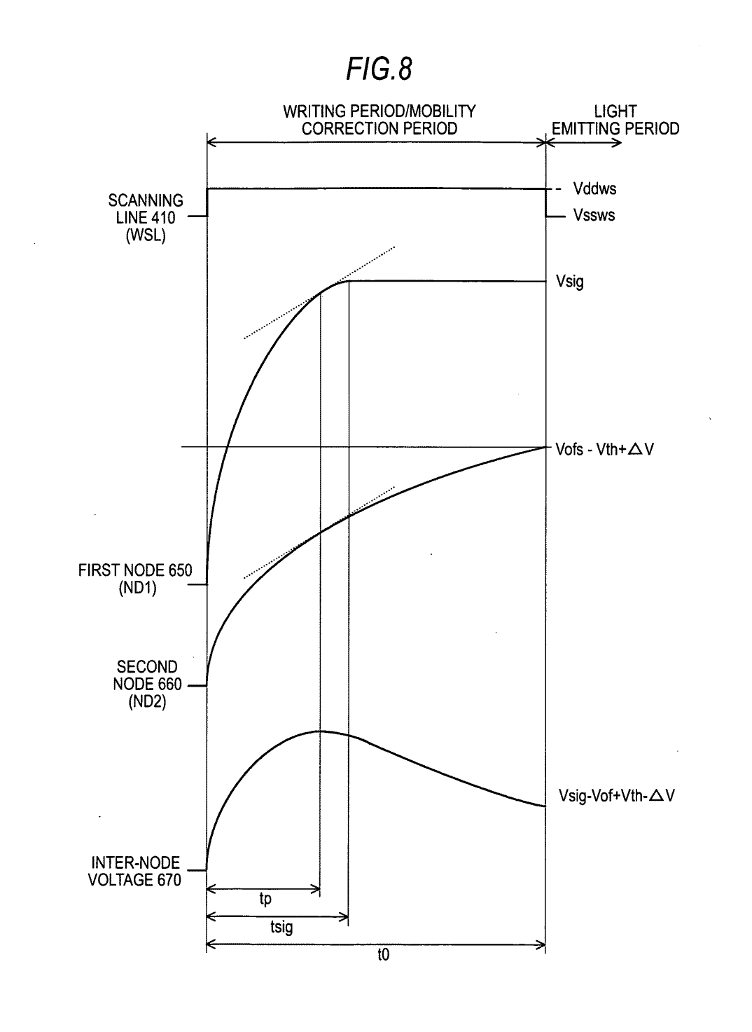

FIG. 8 is a timing chart for explaining an example of the potential difference between the first node (ND1) 650 and the second node (ND2) 660 in the writing period/mobility correction period. With the abscissa set as a common time axis, potential changes in the scanning line (WSL) 410, the first node (ND1) 650, and the second node (ND2) 660 and an amplitude change of the inter-node voltage 670 are represented. Lengths on the abscissa indicating periods are schematic and do not indicate ratios of time lengths of the periods.

On the scanning line (WSL) 410, a potential change of a scanning signal in the writing period/mobility correction period in the related art is represented. Timing when the potential of the scanning line (WSL) 410 transitions from the non-conduction potential (Vssws) to the conduction potential (Vddws) is timing when the writing period/mobility correction period begins. Timing when the scanning line (WSL) 410 transitions from the conduction potential (Vddws) to the non-conduction potential (Vssws) is timing when the writing period/mobility correction period ends.

The potential of the first node (ND1) 650 suddenly rises from the timing when the writing period/mobility correction period begins and reaches the potential (Vsig) of the video signal after the elapse of a predetermined period (tsig).

The potential of the second node (ND2) 660 gently rises from the timing when the writing period/mobility correction period begins and reaches the mobility correction amount (ΔV) at the timing when the writing period/mobility correction period (t0) ends.

The inter-node voltage 670 is voltage (a potential difference) between the first node (ND1) 650 and the second node (ND2) 660. The inter-node voltage 670 suddenly increases immediately after the writing period/mobility correction period begins and reaches the maximum voltage (tp) before the potential of the first node (ND1) 650 is maximized (tsig). The inter-node voltage 670 gently decreases after the elapse of the period tp and reaches “Vsig−Vofs+Vth−ΔV” at timing when the period t0 ends.

In this way, the inter-node voltage 670 is maximized when the period tp elapses. Specifically, the correction acceleration period is started at the timing of the elapse of the period tp when the inter-node voltage 670 is maximized. Therefore, speed of the rise in the potential of the second node (ND2) 660 is maximized.

A second embodiment of the present invention in which the correction acceleration period is started at timing when the inter-node voltage 670 is substantially maximized is explained with reference to the drawings.

### 3. Second Embodiment of the Present Invention

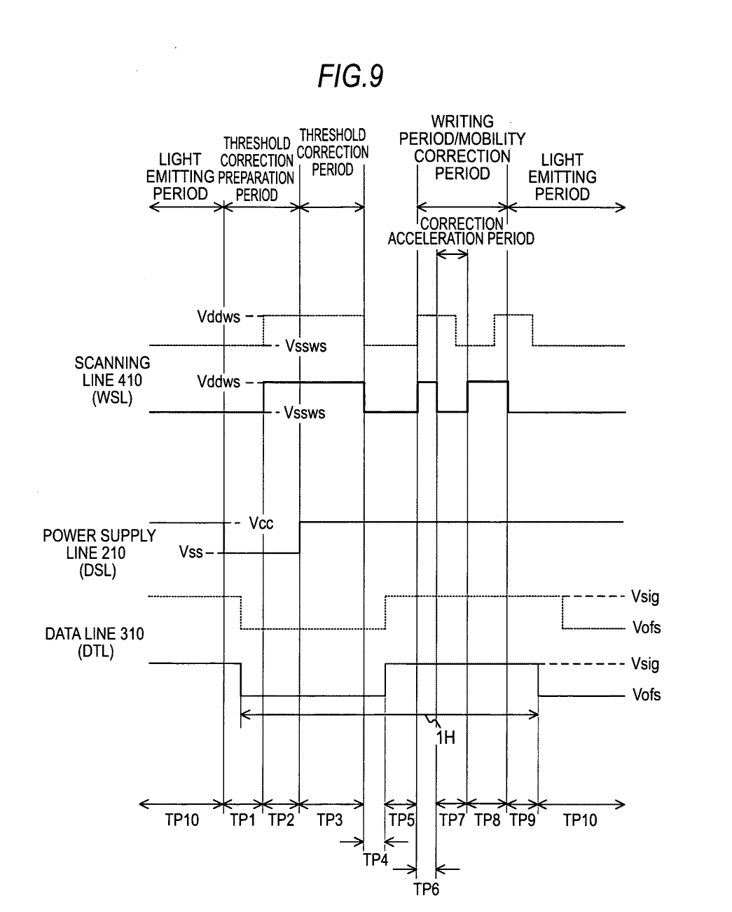

FIG. 9 is a timing chart concerning an operation example of the pixel circuit 600 in the second embodiment. In the second embodiment, the supply of the conduction potential of the scanning signal supplied from the scanning line (WSL) 410 is ended at timing when a potential difference between the first node (ND1) 650 and the second node (ND2) 660 is substantially maximized. With the abscissa set as a common time axis, potential changes in the scanning line (WSL) 410, the power supply line (DSL) 210, and the data line (DTL) 310 are represented. Concerning the scanning line (WSL) 410 and the data line (DTL) 310, the potential changes in the second embodiment are indicated by solid lines and the potential changes in the first embodiment shown in FIG. 3 are indicated by broken lines. Lengths on the abscissa indicating periods are schematic and do not indicate ratios of time lengths of the periods. Operations in the periods other than the mobility correction period TP6 are the same as the operations in the first embodiment of the pixel circuit 600 shown in FIG. 3. Therefore, explanation of the operations is omitted.

In the writing period/mobility correction period TP6 in the second embodiment, the potential of the scanning signal in the scanning line (WSL) 410 is raised to the conduction potential (Vddws). Subsequently, the potential of the scanning signal in the scanning line (WSL) 410 is dropped to the non-conduction potential (Vssws) at the timing when the inter-node voltage 670 shown in FIG. 8 is substantially maximized. The operation transitions to the correction acceleration period TP7. For example, when the writing period/mobility correction period TP6 in FIG. 3 ends after the period tp shown in FIG. 8 elapses, the writing period/mobility correction period TP6 in the second embodiment is shorter than the writing period/mobility correction period TP6 shown in FIG. 3.

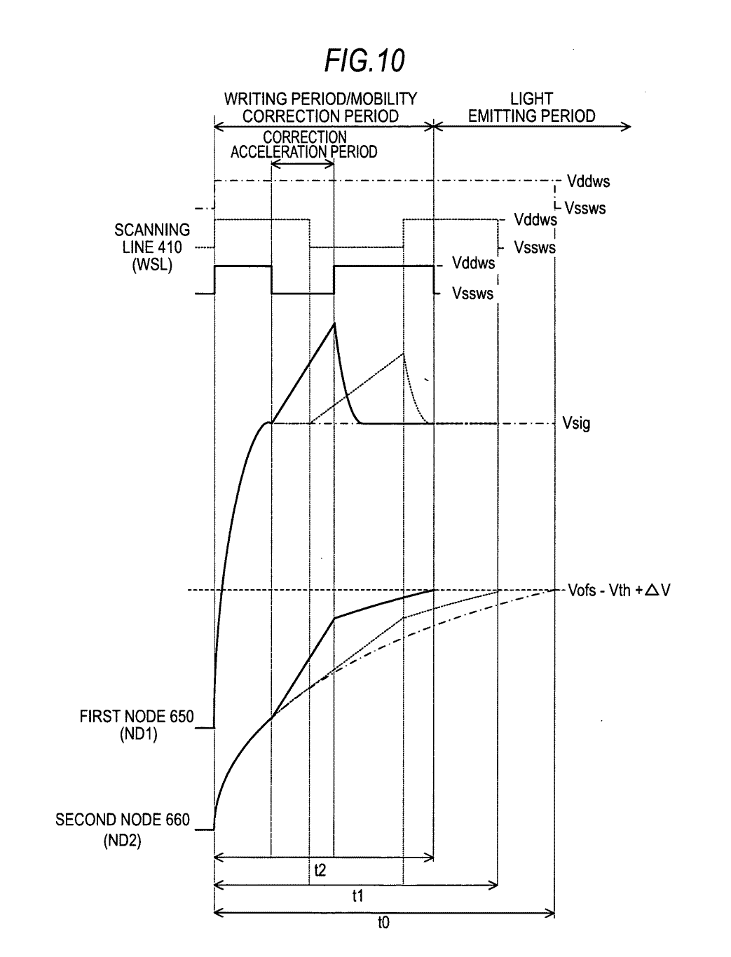

FIG. 10 is a timing chart concerning potential changes in the first node (ND1) 650 and the second node (ND2) 660 in an operation example of the pixel circuit 600 in the second embodiment. With the abscissa set as a common time axis, potential changes in the scanning line (WSL) 410, the first node (ND1) 650, and the second node (ND2) 660 are represented. Concerning the scanning line (WSL) 410, the first node (ND1) 650, and the second node (ND2) 660, the potential changes in the second embodiment are indicated by solid lines, the potential changes in the first embodiment are indicated by broken lines, and the potential changes in the embodiment of the related art are indicated by chain lines. Lengths on the abscissa indicating periods are schematic and do not indicate ratios of time lengths of the periods.

The potential of the scanning signal in the scanning line (WSL) 410 in the second embodiment changes to the conduction potential (Vddws) at the timing when the writing period/mobility correction period begins. Consequently, the potentials of the first node (ND1) 650 and the second node (ND2) 660 rise. At the timing when the inter-node voltage 670 shown in FIG. 8 is substantially maximized, the potential of the scanning signal in the scanning line (WSL) 410 changes to the non-conduction potential (Vssws), whereby the correction acceleration period begins. In the correction acceleration period, speed of the rise in the potential of the second node (ND2) 660 depends on voltage between the first node (ND1) 650 and the second node (ND2) 660. Therefore, the speed of the rise in the potential of the second node (ND2) 660 in the second embodiment is high compared with the case in which the correction acceleration period is started at other timing.

The potential of the scanning line (WSL) 410 in the second embodiment changes to the conduction potential (Vddws) at predetermined timing, whereby the correction acceleration period ends. Consequently, the potential of the first node (ND1) 650 quickly falls to the potential (Vsig) of the video signal. On the other hand, the potential of the second node (ND2) 660 gently rises to reach “Vofs−Vth+ΔV”.

At timing when the potential of the second node (ND2) 660 rises by the rising amount (ΔV) by the mobility correction, the potential of the scanning line (WSL) 410 changes to the non-conduction potential (Vssws), whereby the writing period/mobility correction period (t2) ends.

In this way, the correction acceleration period is started at the timing when the inter-node voltage 670 is substantially maximized. This makes it possible to increase the speed of the rise in the potential of the second node (ND2) 660 compared with the case in which the correction acceleration period is started at other timing. Consequently, it is possible to reduce the writing period/mobility correction period compared with the case in which the correction acceleration period is started at other timing. For example, the writing period/mobility correction period (t2) in the second embodiment is shorter than the writing period/mobility correction period (t1) in the first embodiment shown in FIG. 3 in which the correction acceleration period is started at the predetermined timing after the elapse of the period tp.

In the example explained above, the first correction acceleration period TP7 is started at the timing when the inter-node voltage 670 is substantially maximized. However, timing when the correction acceleration period TP7 is stared is not limited to this. For example, when plural correction acceleration periods TP7 are set by repeating switching of the potential of the scanning signal in the scanning line (WSL) 410 plural times, the second and subsequent correction acceleration periods TP7 may be started at timing when the inter-node voltage 670 is substantially maximized.

An embodiment of the present invention in which the mobility correction period is reduced with parasitic capacitance generated in the writing transistor 610 and the driving transistor 620 taken into account is explained below with reference to the drawings.

### 4. Parasitic Capacitances of a Pixel in an Embodiment of the Present Invention

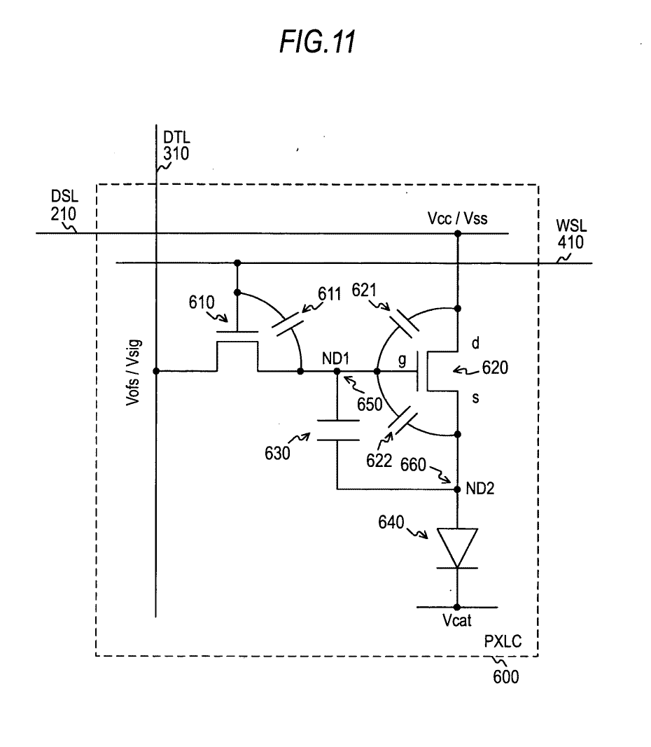

FIG. 11 is a schematic circuit diagram of parasitic capacitances of the writing transistor 610 and the driving transistor 620 in the display device 100 according to an embodiment of the present invention. In the examples explained above, an ideal state is assumed with parasitic capacitances neglected. However, in an actual circuit, a certain degree of parasitic capacitance is present. In the pixel circuit 600, parasitic capacitances of the writing transistor 610 and the driving transistor 620 in the pixel circuit 600 shown in FIG. 2 are shown. Components other than a parasitic capacitance 611, a parasitic capacitance 621, and a parasitic capacitance 622 are the same as those shown in FIG. 2. Therefore, the components are denoted by reference numerals and signs same as those in FIG. 2 and explanation of the components is omitted.

The parasitic capacitance 611 is capacitance generated between the gate terminal and the source terminal of the writing transistor 610. When the potential of the scanning signal in the scanning line (WSL) 410 changes, the potential of the first node (ND1) 650 changes according to capacitive coupling through the parasitic capacitance 611. For example, when the potential of the scanning signal in the scanning line (WSL) 410 suddenly changes from the non-conduction potential (Vssws) to the conduction potential (Vddws), the potential of the first node (ND1) 650 rises by an amount corresponding to the capacitance of the parasitic capacitance 611.

The parasitic capacitance 621 is capacitance generated between the gate terminal (g) and the drain terminal (d) of the driving transistor 620. When the power supply potential of the power supply line (DSL) 210 changes, the potential of the first node (ND1) 650 changes according to capacitive coupling through the parasitic capacitance 621. For example, when the potential of the power supply line (DSL) 210 suddenly changes from the initialization potential to the power supply potential, the potential of the first node (ND1) 650 rises by an amount corresponding to the capacitance of the parasitic capacitance 621.

The parasitic capacitance 622 is capacitance generated between the gate terminal (g) and the source terminal (s) of the driving transistor 620. When the potential of the first node (ND1) 650 changes, the potential of the second node (ND2) 660 changes according to capacitive coupling through the parasitic capacitance 622. When the potential of the second node (ND2) 660 changes, the potential of the first node (ND1) 650 changes according to the capacitive coupling through the parasitic capacitance 622.

In this way, in the actual pixel circuit (PXLC) 600, the influence of the parasitic capacitances in the writing transistor 610 and the driving transistor 620 has to be taken into account. In some case, the parasitic capacitances prevent the potential of the first node (ND1) 650 from rising in the correction acceleration period.

A third embodiment of the present invention in which the correction acceleration period is reduced with the influence of the parasitic capacitances of the driving transistor 620 in the correction acceleration period taken into account is explained below with reference to the drawings.

### 5. Third Embodiment of the Present Invention

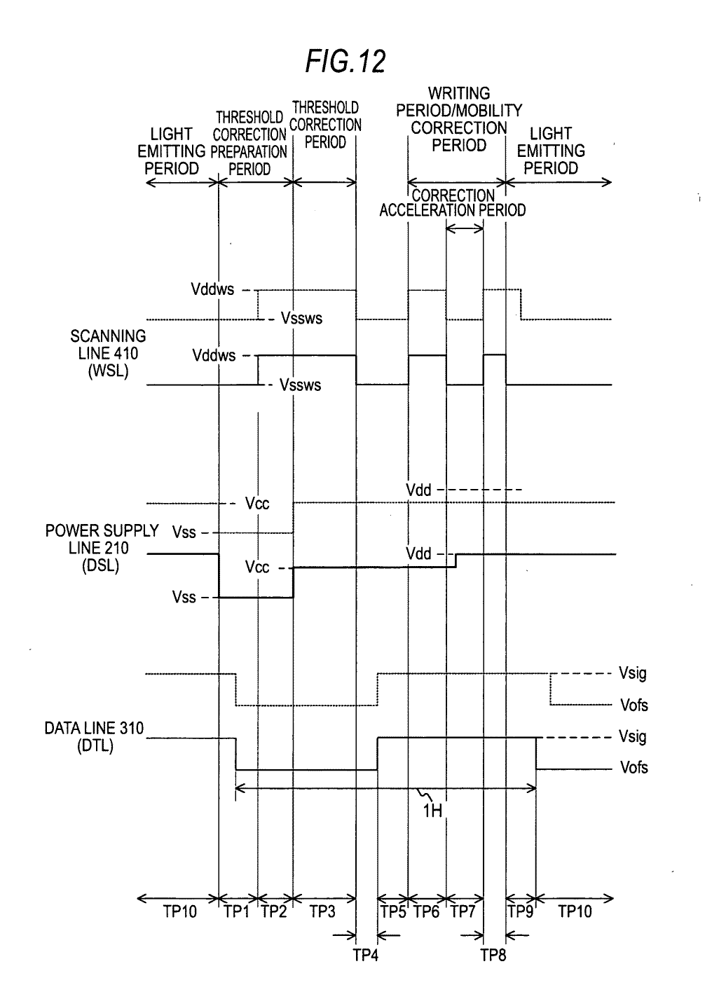

FIG. 12 is a timing chart concerning an operation example of the pixel circuit 600 in the third embodiment. In the third embodiment, the potential of the power supply signal supplied from the power supply line (DSL) 210 is raised in the correction acceleration period, whereby the potential of the first node (ND1) 650 is raised through the parasitic capacitances of the driving transistor 620. With the abscissa set as a common time axis, potential changes in the scanning line (WSL) 410, the power supply line (DSL) 210, and the data line (DTL) 310 are represented. Concerning the scanning line (WSL) 410, the power supply line (DSL) 210, and the data line (DTL) 310, the potential changes in the third embodiment are indicated by solid lines and the potential changes in the first embodiment shown in FIG. 3 are indicated by broken lines. Lengths on the abscissa indicating periods are schematic and do not indicate ratios of time lengths of the periods. Operations in the periods other than the correction acceleration period TP7 are the same as the operations in the first embodiment of the pixel circuit 600 shown in FIG. 3. Therefore, explanation of the operations is omitted.

In the correction acceleration period TP7 in the third embodiment, the potential of the power supply line (DSL) 210 is raised from the power supply potential (Vcc) to high-level power supply potential (Vdd) at timing set in advance in order to reduce the writing period/mobility correction period. Consequently, the potential of the first node (ND1) 650 rises because of the influence of the capacitive coupling through the parasitic capacitance 621 shown in FIG. 11. Therefore, a potential difference between the first node (ND1) 650 and the second node (ND2) 660 is large compared with the potential difference in the first embodiment and speed of the rise in the potential of the second node (ND2) 660 is high compared with the speed in the first embodiment. The potential of the scanning signal in the scanning line (WSL) 410 is raised to the conduction potential (Vddws) at predetermined timing. The operation transitions to the writing period/mobility correction period TP8. Consequently, in the third embodiment, it is possible to reduce the writing period/mobility correction period compared with the writing period/mobility correction period in the first embodiment.

Potential changes of the first node (ND1) 650 and the second node (ND2) 660 according to switching of the power supply signal to the high-level power supply potential (Vdd) are explained below with reference to the drawings.

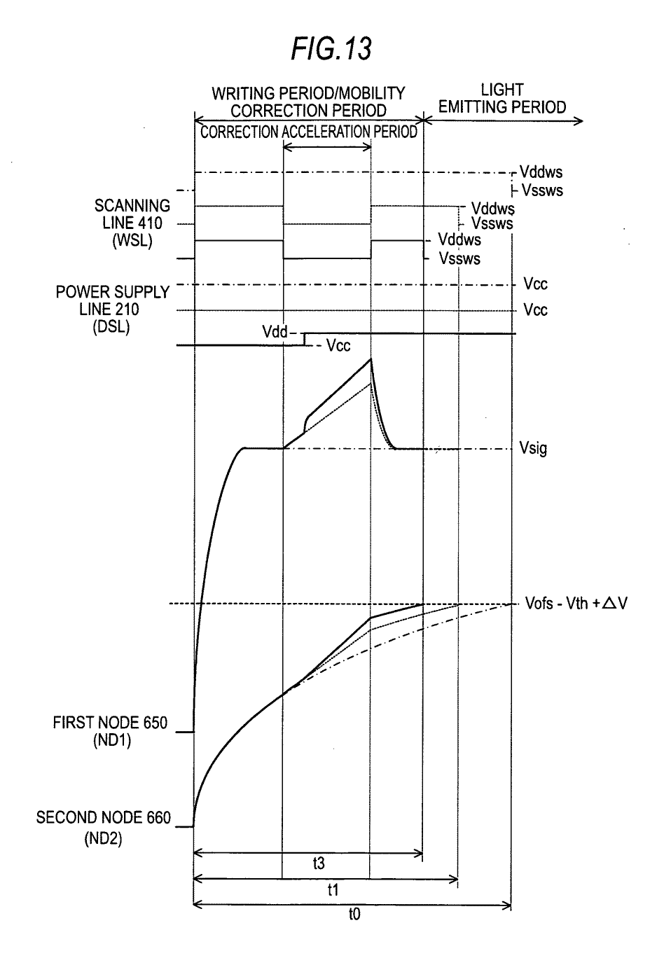

FIG. 13 is a timing chart concerning potential changes in the first node (ND1) 650 and the second node (ND2) 660 in an operation example of the pixel circuit 600 in the third embodiment. With the abscissa set as a common time axis, potential changes in the scanning line (WSL) 410, the power supply line (DSL) 210, the first node (ND1) 650, and the second node (ND2) 660 are represented. Concerning the represented potential changes, the potential changes in the third embodiment are indicated by solid lines, the potential changes in the first embodiment are indicated by broken lines, and the potential changes in the embodiment of the related art are indicated by chain lines. Lengths on the abscissa indicating periods are schematic and do not indicate ratios of time lengths of the periods.

The potential of the scanning signal supplied from the scanning line (WSL) 410 in the third embodiment changes to the conduction potential (Vddws) at timing when the writing period/mobility correction period begins. Consequently, the potentials of the first node (ND1) 650 and the second node (ND2) 660 rise. The potential of the scanning signal supplied from the scanning line (WSL) 410 changes to the non-conduction potential (Vssws) at predetermined timing and the correction acceleration period begins.

In the correction acceleration period in the third embodiment, the potential of the power supply line (DSL) 210 rises from the power supply potential (Vcc) to the high-level power supply potential (Vdd) at predetermined timing. On the other hand, in related art indicated by the chain line and the first embodiment indicated by the broken line, the potential of the power supply line (DSL) 210 does not change from the power supply potential (Vcc). Consequently, the potential of the first node (ND1) 650 in the third embodiment rises according to the rise in the power supply signal supplied from the power supply line (DSL) 210 because of the influence of the capacitive coupling through the parasitic capacitance 621 shown in FIG. 11. Therefore, the potential of the first node (ND1) 650 is higher than the potential of the first node (ND1) 650 in the first embodiment. The potential of the first node (ND1) 650 rises, whereby the potential difference between the first node (ND1) 650 and the second node (ND2) 660 increases compared with the potential difference in the first embodiment. The potential difference between the first node (ND1) 650 and the second node (ND2) 660 increases, whereby speed of the rise in the potential of the second node (ND2) 660 increases.

Thereafter, the power supply signal supplied from the scanning line (WSL) 410 in the third embodiment changes to the conduction potential (Vddws) at predetermined timing, whereby the correction acceleration period ends. Consequently, the potential of the first node (ND1) 650 quickly falls to the potential (Vsig) of the video signal. On the other hand, the potential of the second node (ND2) 660 gently rises to reach “Vofs−Vth+ΔV”.

At timing when the potential of the second node (ND2) 660 rises by the rising amount (ΔV) by the mobility correction, the potential of the scanning line (WSL) 410 changes to the non-conduction potential (Vssws), whereby the writing period/mobility correction period (t3) ends.

In this way, by raising the potential of the power supply signal supplied from the power supply line (DSL) 210 in the correction acceleration period, it is possible to raise the potential of the first node (ND1) 650 according to the capacitive coupling through the parasitic capacitance 621 shown in FIG. 11. The potential difference between the first node (ND1) 650 and the second node (ND2) 660 increases, whereby the speed of the rise in the potential of the second node (ND2) 660 increases. Consequently, in the third embodiment, compared with the case in which the power supply signal supplied from the power supply line (DSL) 210 is fixed in the correction acceleration period explained in the first embodiment, it is possible to quickly raise the potential of the second node (ND2) 660 to the predetermined potential. Specifically, in the third embodiment, it is possible to reduce the writing period/mobility correction period compared with the case in which the power supply potential supplied from the power supply line (DSL) 210 is fixed in the correction acceleration period. For example, the writing period/mobility correction period (t3) in the third embodiment is shorter than the writing period/mobility correction period (t1) in the first embodiment in which the power supply signal supplied from the power supply line (DSL) 210 is fixed in the correction acceleration period.

In the example explained above, the power supply potential in the power supply line (DSL) 210 is raised only once in the correction acceleration period. However, the raising of the power supply potential is not limited to this. For example, the power supply signal supplied from the power supply line (DSL) 210 in the correction acceleration period may be raised plural times. The high-level power supply potential (Vdd) is an example of power supply potential that is high compared with potential during the start of the mobility correction period described in the appended claims.

A fourth embodiment of the present invention in which the influence of the parasitic capacitances of the writing transistor 610 in the correction acceleration period is reduced is explained below with reference to the drawings.

### 6. Fourth Embodiment of the Present Invention

### Configuration Example of the Write Scanner

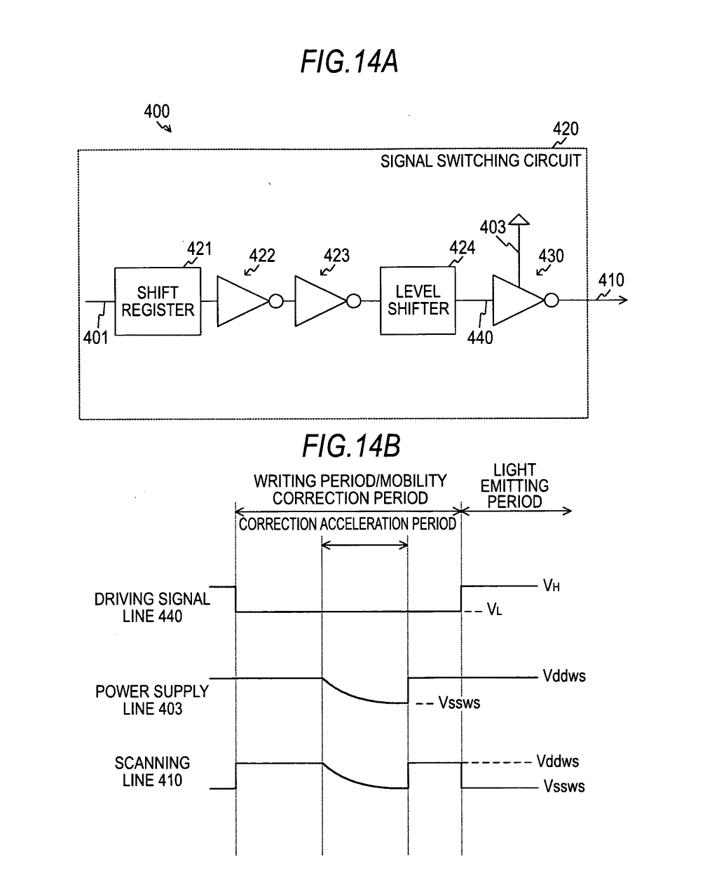

FIGS. 14A and 14B are diagrams of a configuration example of the write scanner (WSCN) 400 in an operation example of the pixel circuit 600 in the fourth embodiment. In the fourth embodiment, potential supplied to the scanning line 410 is gently dropped to start the correction acceleration period, whereby the influence of capacitive coupling due to the parasitic capacitances of the writing transistor 610 is reduced. FIG. 14A is a block diagram of a configuration example of the write scanner (WSCN) 400 in the fourth embodiment. FIG. 14B is a timing chart concerning an operation example in the writing period/mobility correction period in the configuration shown in FIG. 2A.

In FIG. 14A, a signal switching circuit 420 that sequentially supplies scanning signals to the scanning lines (WSL) 410 wired in respective rows in the write scanner (WSCN) 400 is shown.

The signal switching circuit 420 generates a scanning signal on the basis of an input signal supplied via an input signal line 401. The signal switching circuit 420 supplies the generated scanning signal to the pixel circuits 600 in the respective rows via the scanning lines (WSL) 410.

The signal switching circuit 420 includes a shift register 421, an intermediate buffer 422, an intermediate buffer 423, a level shifter 424, and an output buffer 430.

The shift register 421 delays an input signal transferred via the input signal line 401 from the signal switching circuit 420 in the immediately preceding row by time necessary for controlling the pixel circuit 600 in one row with respect to the transferred input signal. The shift register 421 supplies the delayed input signal to the level shifter 424 via the intermediate buffer 422 and the intermediate buffer 423.

The level shifter 424 generates, from the delayed input signal supplied from the shift register 421, an output buffer driving signal having potential suitable for driving the output buffer 430. The level shifter 424 supplies the generated output buffer driving signal to the output buffer 430 via a driving signal line 440.

The output buffer 430 generates a scanning signal for the pixel circuit 600 on the basis of the output buffer driving signal supplied via the driving signal line 440 and power supply potential supplied via a power supply line 403. The output buffer 430 supplies the generated scanning signal to the pixel circuit 600 via the scanning line (WSL) 410.

In FIG. 14B, a change in potential supplied from the driving signal line 440 to the output buffer 430 and a potential change in the writing period/mobility correction period of power supplied from the power supply line 403 are shown. A scanning signal supplied to the pixel circuit 600 via the scanning line 410 is shown. The scanning signal is generated on the basis of a signal supplied from the driving signal line 440 to the output buffer 430 and the power supplied from the power supply line 403.

In the writing period/mobility correction period, the input signal supplied from the driving signal line 440 transitions to potential at an H level (V_{H}) to a potential at an L level (V_{L}) at timing when the writing period/mobility correction period begins. The input signal transitions from the potential at the L level (V_{L}) to the potential at the H level (V_{H}) at timing when the writing period/mobility correction period ends.

The potential of the power supplied from the power supply line 403 gradually falls from potential at an H level (Vddws) to potential at an L level (Vssws) at timing when the correction acceleration period begins. Specifically, the potential of the power changes such that a falling characteristic becomes gentle. The potential of the power supplied from the power supply line 403 transitions from the potential at the L level Vssws) to the potential at the H level (Vddws) at timing when the correction acceleration period ends.

The scanning signal supplied from the scanning line 410 transitions from the non-conduction potential (Vssws) to the conduction potential (Vddws) at the timing when writing period/mobility correction period begins. The scanning signal transitions from the conduction potential (Vddws) to the non-conduction potential (Vssws) at the timing when the correction acceleration period begins. The scanning signal transitions from the non-conduction potential (Vssws) to the conduction potential (Vddws) at the timing when the correction acceleration period ends.

In this way, the potential of the power supplied from the power supply line 403 is gently changed. This makes it possible to gently change the potential of the scanning signal supplied to the pixel circuit 600 via the scanning line (WSL) 410.

The fourth embodiment in which a falling characteristic of the scanning signal supplied from the scanning line (WSL) 410 is set gentle to start the correction acceleration period is explained with reference to the drawings.

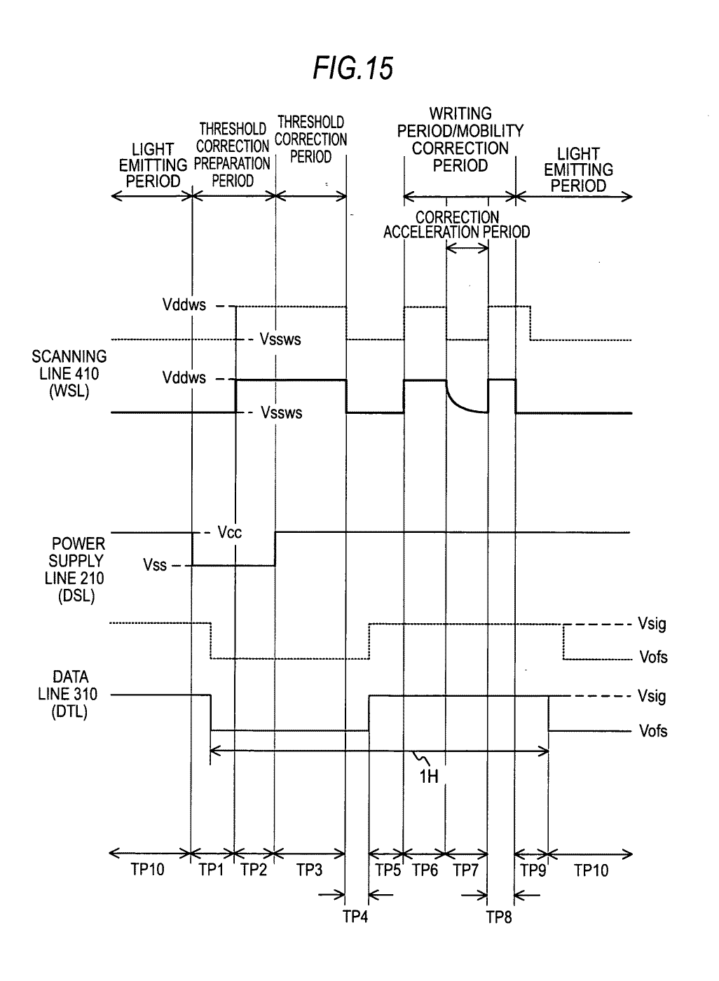

FIG. 15 is a timing chart concerning an operation example of the pixel circuit 600 in the fourth embodiment. With the abscissa set as a common time axis, potential changes in the scanning line (WSL) 410, the power supply line (DSL) 210, and the data line (DTL) 310 are represented. Concerning the scanning line (WSL) 410 and the data line (DTL) 310, the potential changes in the fourth embodiment are indicated by solid lines and the potential changes in the first embodiment shown in FIG. 3 are indicated by broken lines. Lengths on the abscissa indicating periods are schematic and do not indicate ratios of time lengths of the periods. Operations in the periods other than the correction acceleration period TP7 are the same as the operations in the first embodiment of the pixel circuit 600 shown in FIG. 3. Therefore, explanation of the operations is omitted.

In the correction acceleration period TP7 in the fourth embodiment, the potential of the scanning signal supplied from the scanning line (WSL) 410 gently transitions from the conduction potential (Vddws) to the non-conduction potential (Vssws). Specifically, the write scanner (WSCN) 400 supplies a scanning signal having a falling characteristic that is gentle compared with a change in potential (a rising characteristic) from the non-conduction potential (Vssws) to the conduction potential (Vddws) during the start of the writing period/mobility correction period TP6. The signal having the gentle falling characteristic means a scanning signal, a change in the potential thereof gently transitions from the conduction potential (Vddws) to the non-conduction potential (Vssws).

At predetermined timing, the potential of the scanning signal supplied from the scanning line (WSL) 410 rises from the non-conduction potential (Vssws) to the conduction potential (Vddws), whereby the writing period/mobility correction period TP8 begins.

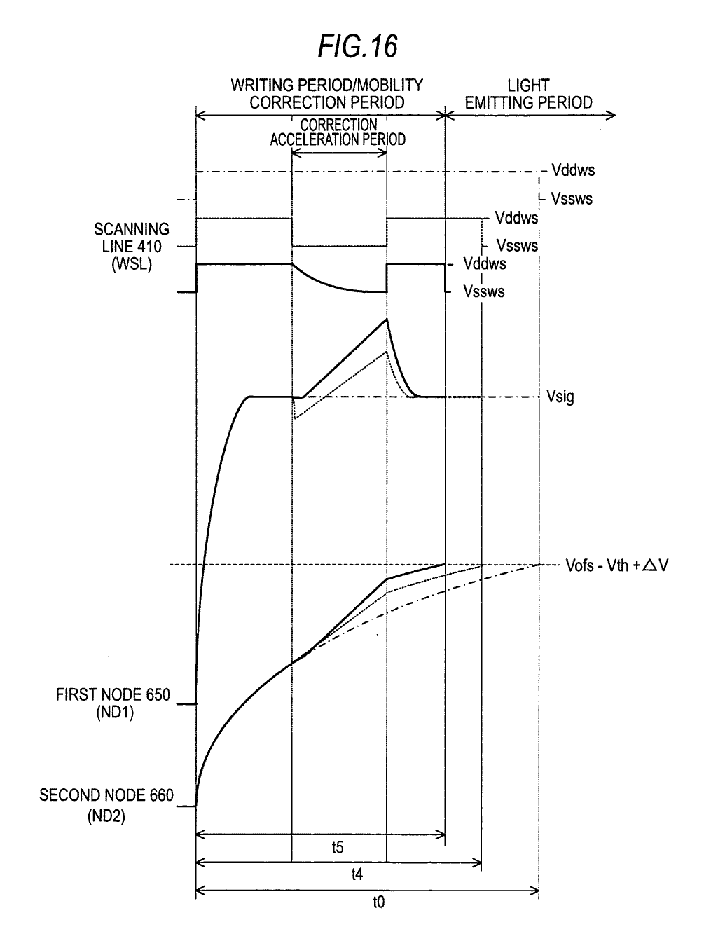

FIG. 16 is a timing chart concerning potential changes in the first node (ND1) 650 and the second node (ND2) 660 in an operation example of the pixel circuit 600 in the fourth embodiment. With the abscissa set as a common time axis, potential changes in the scanning line (WSL) 410, the first node (ND1) 650, and the second node (ND2) 660 are represented. Concerning the scanning line (WSL) 410, the first node (ND1) 650, and the second node (ND2) 660, the potential changes in the fourth embodiment are indicated by solid lines, the potential changes in the first embodiment are indicated by broken lines, and the potential changes in the embodiment of the related art are indicated by chain lines. Lengths on the abscissa indicating periods are schematic and do not indicate ratios of time lengths of the periods.

The potential of the scanning signal in the scanning line (WSL) 410 in the fourth embodiment changes to the conduction potential (Vddws) at the timing when writing period/mobility correction period begins. Consequently, the potentials of the first node (ND1) 650 and the second node (ND2) 660 rise. The potential of the scanning signal supplied from the scanning line (WSL) 410 gently falls to reach the non-conduction potential (Vssws) at predetermined timing. In this case, since the falling characteristic of the scanning signal supplied from the scanning line (WSL) 410 is set gentle, the potential of the first node (ND1) 650 in the fourth embodiment is hardly affected by the influence of the parasitic capacitances of the writing transistor 610. Therefore, the potential of the first node (ND1) 650 hardly falls after the correction acceleration period is started. On the other hand, in the first embodiment indicated by the broken line, because of the sudden potential change of the scanning signal in the scanning line (WSL) 410 during the start of the correction acceleration period, the potential of the first node (ND1) 650 falls according to the capacitive coupling through the parasitic capacitance 611 shown in FIG. 12. Consequently, a potential difference between the first node (ND1) 650 and the second node (ND2) 660 in the fourth embodiment is larger than the potential difference in the first embodiment. Therefore, speed of the rise in the potential of the second node (ND2) 660 in the fourth embodiment is high compared with the speed of the rise in the potential of the second node (ND2) 660 in the first embodiment.

The scanning signal supplied from the scanning line (WSL) 410 in the fourth embodiment transitions to the conduction potential (Vddws) at predetermined timing, whereby the correction acceleration period ends. Consequently, the potential of the first node (ND1) 650 quickly falls to the potential (Vsig) of the video signal. On the other hand, the potential of the second node (ND2) 660 gently rises to reach “Vofs−Vth+ΔV”.

At timing when the potential of the second node (ND2) 660 rises by the rising amount (ΔV) by the mobility correction, the scanning line (WSL) 410 is switched to the non-conduction potential (Vssws), whereby the writing period/mobility correction period (t5) ends.

In this way, in the fourth embodiment, the influence of the coupling due to the parasitic capacitances of the writing transistor 610 is reduced. Consequently, in the fourth embodiment, it is possible to reduce the writing period/mobility correction period (t5) compared with the writing period/mobility correction period (t4) in the first embodiment.

### 7. Fifth Embodiment of the Present Invention

### Configuration Example of the Output Buffer

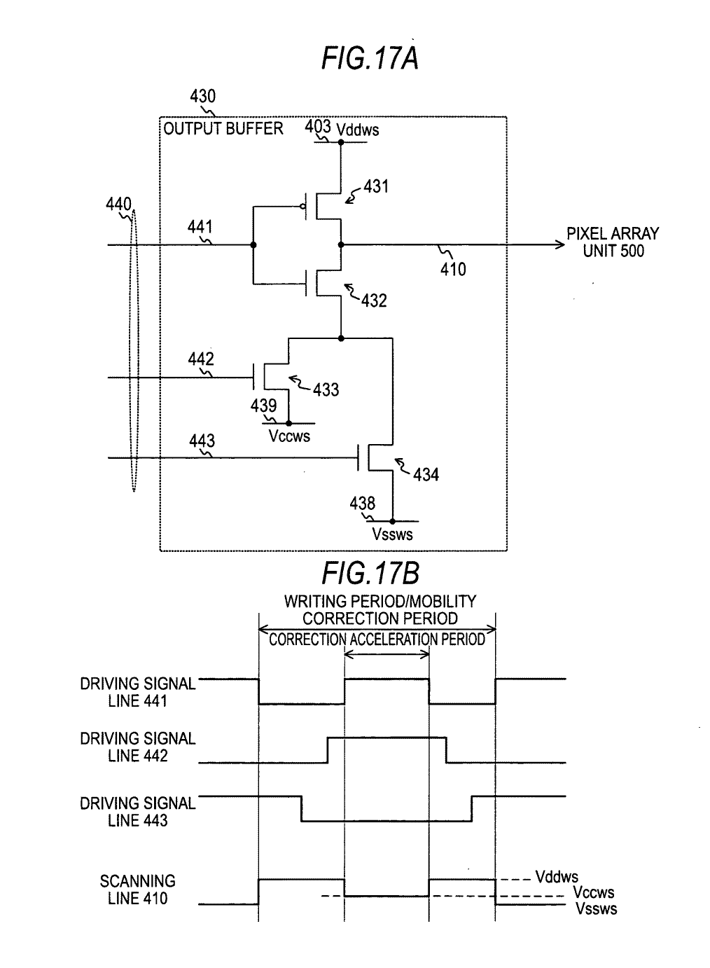

FIGS. 17A and 17B are diagrams of an example of a method of generating a ternarized scanning signal by the output buffer 430 in a fifth embodiment of the present invention. In the fifth embodiment, potential supplied to the scanning line 410 is ternarized, whereby the influence of the capacitive coupling due to the parasitic capacitances of the writing transistor 610 is reduced. FIG. 17A is a circuit diagram of a configuration example of the output buffer 430 in the fifth embodiment. FIG. 17B is a timing chart concerning an operation example in the writing period/mobility correction period in the configuration shown in FIG. 17A.

In FIG. 17A, the output buffer 430 that generates a ternary scanning signal on the basis of three driving signal lines 441 to 443 is shown.

The output buffer 430 includes a p-type transistor 431 and n-type transistors 432 to 434. Further, the output buffer 430 includes the power supply line 403, a non-conduction potential line 438, a high-level non-conduction potential line 439, the driving signal lines 441 to 443, and the scanning line (WSL) 410.

In this configuration, the driving signal line 441 is connected to a gate terminal of the p-type transistor 431. The power supply line 403 is connected to a source terminal of the p-type transistor 431. The scanning line (WSL) 410 and a drain terminal of the n-type transistor 432 are connected to a drain terminal of the p-type transistor 431. The driving signal line 441 is connected to a gate terminal of the n-type transistor 432. A drain terminal of the n-type transistor 433 and a drain terminal of the n-type transistor 434 are connected to a source terminal of the n-type transistor 432. The driving signal line 442 is connected to a gate terminal of the n-type transistor 433. The high-level non-conduction potential line 439 is connected to a source terminal of the n-type transistor 433. The driving signal line 443 is connected to a gate terminal of the n-type transistor 434. The non-conduction potential line 438 is connected to a source terminal of the n-type transistor 434.

In order to switch a scanning signal in the scanning line (WSL) 410 to the conduction potential (Vddws), a driving signal for driving the output buffer 430 is supplied to the driving signal line 441. In order to switch the scanning signal in the scanning line (WSL) 410 to high-level non-conduction potential (Vccws), the driving signal for driving the output buffer 430 is supplied to the driving signal line 442. In order to switch the scanning signal in the scanning line (WSL) 410 to the non-conduction potential (Vssws), the driving signal for driving the output buffer 430 is supplied to the driving signal line 443.

The conduction potential (Vddws) for changing the writing transistor 610 to the ON state is supplied to the power supply line 403. The non-conduction potential (Vssws) for changing the writing transistor 610 to the OFF state is supplied to the non-conduction potential line 438. The high-level non-conduction potential (Vccws), which is potential at a higher level than the non-conduction potential (Vssws) and makes gate-to-source voltage of the writing transistor 610 lower than the threshold voltage of the writing transistor 610, is supplied to the high-level non-conduction potential line 439. Therefore, when the high-level non-conduction potential (Vccws) is supplied to the pixel circuit 600 via the scanning line (WSL) 410, the writing transistor 610 changes to the OFF state.

In FIG. 17B, potential changes in the writing period/mobility correction period in the driving signal line 441, the driving signal line 442, the driving signal line 443, and the scanning line 410 in the configuration shown in FIG. 17A are shown.

The driving signal supplied from the driving signal line 441 transitions from potential at an H level to potential at an L level at timing when the writing period/mobility correction period begins. Subsequently, the driving signal transitions from the potential at the L level to the potential at the H level at timing when the correction acceleration period begins. The driving signal supplied from the driving signal line 441 transitions to the potential at the H level at timing when the writing period/mobility correction period ends after transitioning from the potential at the H level to the potential at the L level at timing when the correction acceleration period ends.

The driving signal supplied from the driving signal line 441 supplies the conduction potential (Vddws) to the scanning line (WSL) 410 when the driving signal has the potential at the L level. Specifically, in the writing period/mobility correction period, the conduction potential (Vddws) is supplied to the scanning line (WSL) 410 except in the correction acceleration period.

The driving signal supplied from the driving signal line 442 transitions from the potential at the L level to the potential at the H level after the writing period/mobility correction period begins and before the timing when the correction acceleration period begins. The driving signal transitions from the potential at the H level to the potential at the L level after the correction acceleration period ends and before the timing when the writing period/mobility correction period ends.

In this case, when the driving signal supplied from the driving signal line 442 has the potential at the H level and the driving signal supplied from the driving signal line 441 has the potential at the H level, the output buffer 430 supplies the high-level non-conduction potential (Vccws) to the scanning line (WSL) 410.

The driving signal supplied from the driving signal line 443 transitions from the potential at the H level to the potential at the L level after the writing period/mobility correction period begins and before the driving signal in the driving signal line 442 before the start of the correction acceleration period transitions to the potential at the H level. The driving signal supplied by the driving signal 443 transitions from the potential at the L level to the potential at the H level before the writing period/mobility correction period ends and after the driving signal in the driving signal line 442 after the end of the correction acceleration period transitions to the potential at the L level.

In this case, when the driving signal supplied from the driving signal line 443 has the potential at the H level and the driving signal supplied from the driving signal line 441 has the potential at the H level, the output buffer 430 supplies the non-conduction potential (Vssws) to the scanning line (WSL) 410.

The scanning signal supplied from the scanning line (WSL) 410 transitions, according to the potential changes of the each driving signals supplied from the driving signal lines 441 to 443, from the non-conduction potential (Vssws) to the conduction potential (Vddws) at the timing when the writing period/mobility correction period begins. The scanning signal transitions from the conduction potential (Vddws) to the high-level non-conduction potential (Vccws) at the timing when the correction acceleration period begins. The scanning signal transitions from the high-level non-conduction potential (Vccws) to the conduction potential (Vddws) at the timing when the correction acceleration period ends. Finally, the scanning signal transitions from the conduction potential (Vddws) to the non-conduction potential (Vssws) at the timing when the writing period/mobility correction period ends.

The fifth embodiment in which the potential of the scanning signal supplied from the scanning line (WSL) 410 is changed to the high-level non-conduction potential (Vccws) in the correction acceleration period is explained with reference to the drawings.

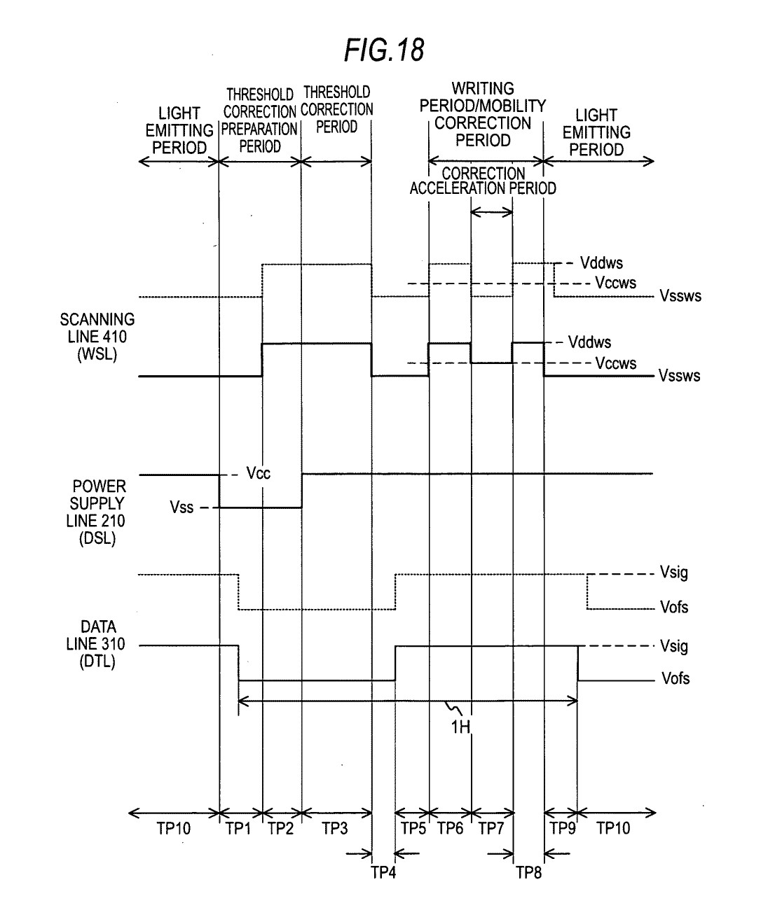

FIG. 18 is a timing chart concerning an operation example of the pixel circuit 600 in the fifth embodiment. With the abscissa set as a common time axis, potential changes in the scanning line (WSL) 410, the power supply line (DSL) 210, and the data line (DTL) 310 are represented. Concerning the scanning line (WSL) 410 and the data line (DTL) 310, the potential changes in the fifth embodiment are indicated by solid lines and the potential changes in the first embodiment shown in FIG. 3 are indicated by broken lines. Lengths on the abscissa indicating periods are schematic and do not indicate ratios of time lengths of the periods. Operations in the periods other than the correction acceleration period TP7 are the same as the operations in the first embodiment of the pixel circuit 600 shown in FIG. 3. Therefore, explanation of the operations is omitted.

At timing when the correction acceleration period TP7 in the fifth embodiment begins, the potential of the scanning signal supplied from the scanning line (WSL) 410 transitions from the conduction potential (Vddws) to the high-level non-conduction potential (Vccws). At predetermined timing, the potential of the scanning signal supplied from the scanning line (WSL) 410 rises from the high-level non-conduction potential (Vccws) to the conduction potential (Vddws), whereby the correction acceleration period TP7 ends.

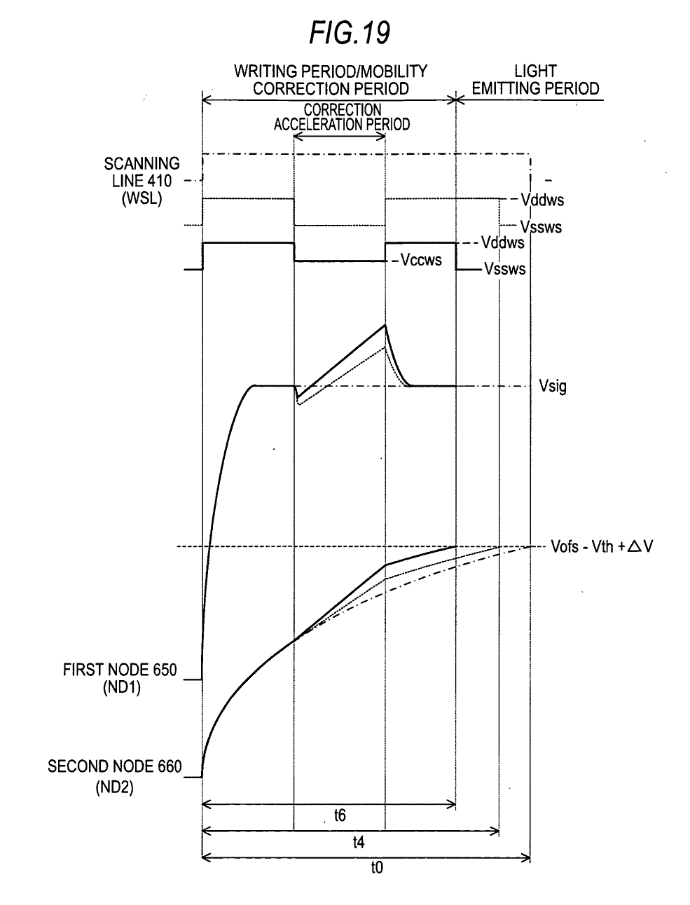

FIG. 19 is a timing chart concerning potential changes in the first node (ND1) 650 and the second node (ND2) 660 in an operation example of the pixel circuit 600 in the fifth embodiment. With the abscissa set as a common time axis, potential changes in the scanning line (WSL) 410, the first node (ND1) 650, and the second node (ND2) 660 are represented. Concerning the scanning line (WSL) 410, the first node (ND1) 650, and the second node (ND2) 660, the potential changes in the fifth embodiment are indicated by solid lines, the potential changes in the first embodiment are indicated by broken lines, and the potential changes in the embodiment of the related art are indicated by chain lines. Lengths on the abscissa indicating periods are schematic and do not indicate ratios of time lengths of the periods.

The potential of the scanning signal in the scanning line (WSL) 410 in the fifth embodiment changes to the conduction potential (Vddws) at the timing when the writing period/mobility correction period begins. Consequently, the potentials of the first node (ND1) 650 and the second node (ND2) 660 rise.

The potential of the scanning signal supplied from the scanning line (WSL) 410 changes to the high-level non-conduction potential (Vccws) at predetermined timing. Consequently, to transition to the correction acceleration period, the potentials of the first node (ND1) 650 and the second node (ND2) 660 suddenly rise. The high-level non-conduction potential (Vccws) is potential at a high level compared with the non-conduction potential (Vssws). Therefore, the influence of coupling due to parasitic capacitances in the transition from the conduction potential (Vddws) to the high-level non-conduction potential (Vccws) is small compared with the transition from the conduction potential (Vddws) to the non-conduction potential (Vssws). Consequently, in the correction acceleration period in the fifth embodiment, the potential difference between the first node (ND1) 650 and the second node (ND2) 660 is larger than the potential difference in the first embodiment. Therefore, speed of the rise in the potential of the second node (ND2) 660 in the fifth embodiment is high compared with the speed of the rise in the potential of the second node (ND2) 660 in the first embodiment.

Thereafter, the scanning signal supplied from the scanning line (WSL) 410 in the fifth embodiment transitions to the conduction potential (Vddws) at predetermined timing, whereby the correction acceleration period ends. Consequently, the potential of the first node (ND1) 650 quickly falls to the potential (Vsig) of the video signal. On the other hand, the potential of the second node (ND2) 660 gently rises to reach “Vofs−Vth+ΔV”.

At timing when the potential of the second node (ND2) 660 rises by the rising amount (ΔV) by the mobility correction, the potential of the scanning line (WSL) 410 changes to the non-conduction potential (Vssws), whereby the writing period/mobility correction period (t6) ends.

In this way, according to the fifth embodiment, by reducing the potential changes due to the parasitic capacitances of the writing transistor 610, it is possible to reduce the writing period/mobility correction period (t6) compared with the writing period/mobility correction period (t4) in the first embodiment. The high-level non-conduction potential (Vccws) is an example of off-potential that is high compared with potential supplied in causing a light emitting element to emit light described in the appended claims.

In this way, according to this embodiment, the potential of the scanning signal is transitions to the off-potential halfway in the writing period/mobility correction period to set the mobility acceleration period. This makes it possible to reduce the mobility correction period.

The display device according to the embodiments has a flat panel shape and can be applied to displays of various electronic apparatuses such as a digital camera, a notebook personal computer, a cellular phone, and a video camera. The display device can also be applied to displays of electronic apparatuses in every field that display, as images or videos, video signals input to the electronic apparatuses and video signals generated in the electronic apparatuses. Examples of the electronic apparatuses to which the display device is applied are explained below.

### 8. Sixth Embodiment of the Present Invention

### Example of Application to an Electronic Apparatus

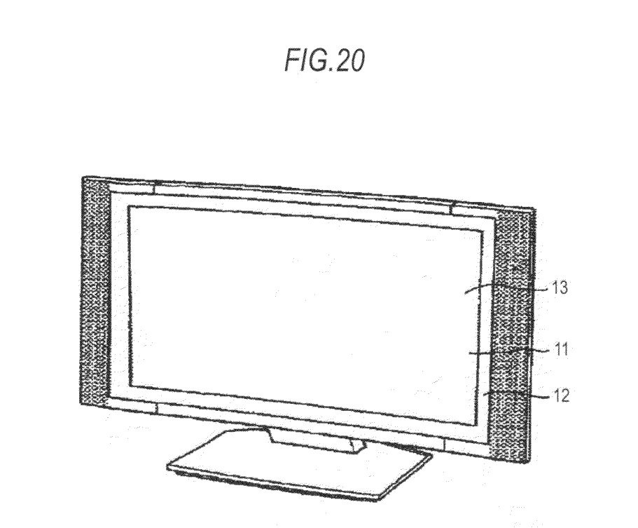

FIG. 20 is a diagram of an example of a television set according to a sixth embodiment of the present invention. The television set is a television set to which the first to fifth embodiments are applied. The television set includes a video display screen 11 including a front panel 12 and a filter glass 13. The television set is manufactured by, for example, using the display device according to the first embodiment in the video display screen 11.

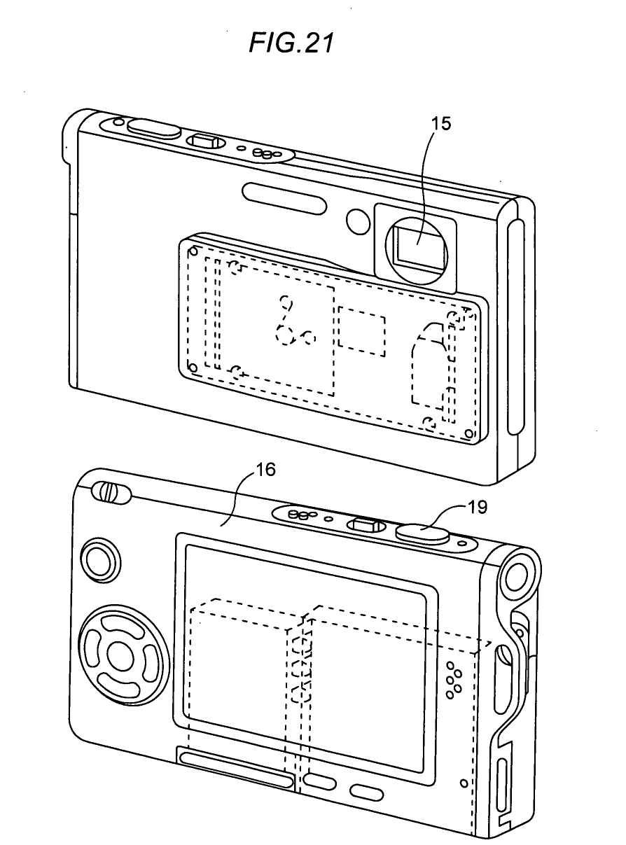

FIG. 21 is a diagram of an example of a digital still camera according to the sixth embodiment. The digital still camera is a digital still camera to which the first to fifth embodiments are applied. A front view of the digital still camera is shown in an upper part of the figure. A rear view of the digital still camera is shown in a lower part of the figure. The digital still camera includes an imaging lens 15, a display unit 16, a control switch, a menu switch, and a shutter 19. The digital still camera is manufactured by using the display device according to the first embodiment in the display unit 16.

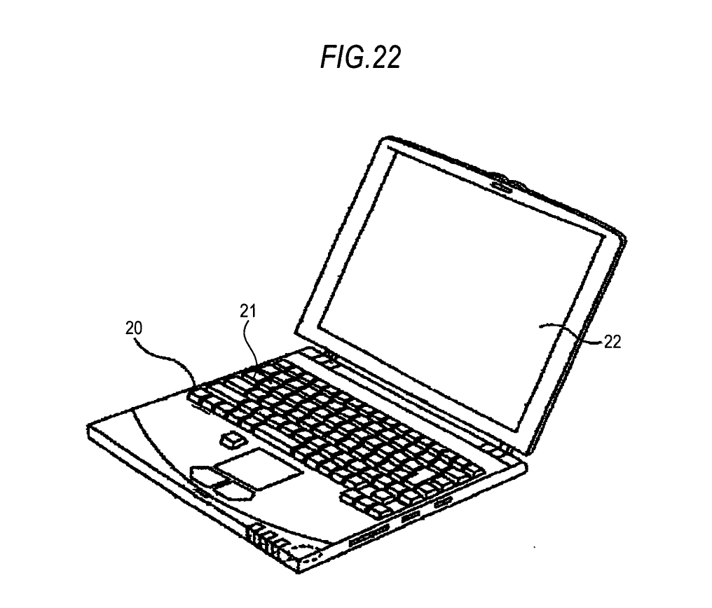

FIG. 22 is a diagram of an example of a notebook personal computer according to the sixth embodiment. The notebook personal computer is a notebook personal computer to which the first to fifth embodiments are applied. The notebook personal computer includes, in a main body 20, a keyboard 21 operated to input characters and the like and includes, in a main body cover, a display unit 22 that displays an image. For example, the notebook personal computer is manufactured by using the display device according to the first embodiment in the display unit 22.

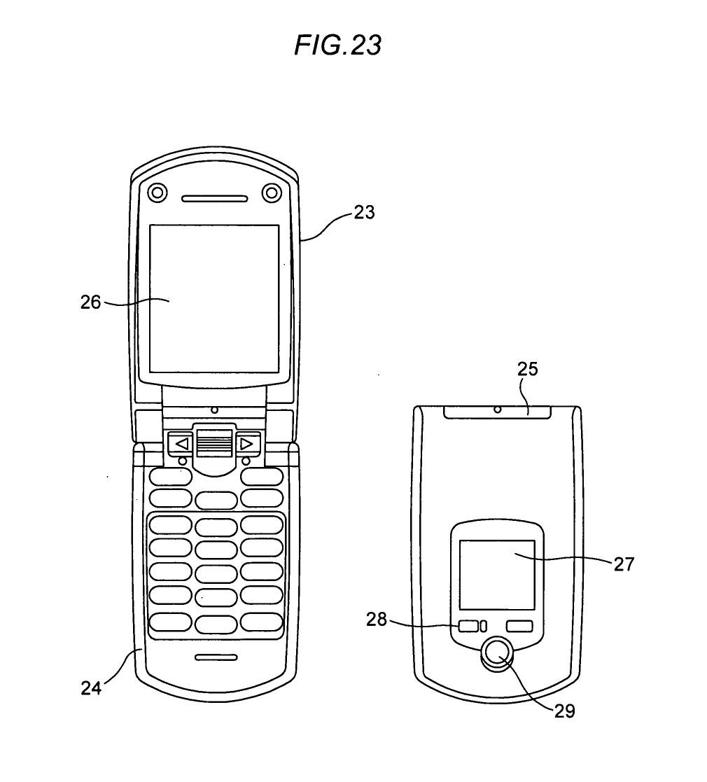

FIG. 23 is a diagram of an example of a portable terminal apparatus according to the sixth embodiment. The portable terminal apparatus is a portable terminal apparatus to which the first to fifth embodiments are applied. An open state of the portable terminal apparatus is shown on the left side in the figure. A closed open state of the portable terminal apparatus is shown on the right side of the figure. The portable terminal apparatus includes an upper housing 23, a lower housing 24, a connecting section (a hinge section) 25, a display 26, a sub-display 27, a picture light 28, and a camera 29. For example, the portable terminal apparatus is manufactured by using the display device according to the first embodiment in the display 26 and the sub-display 27.

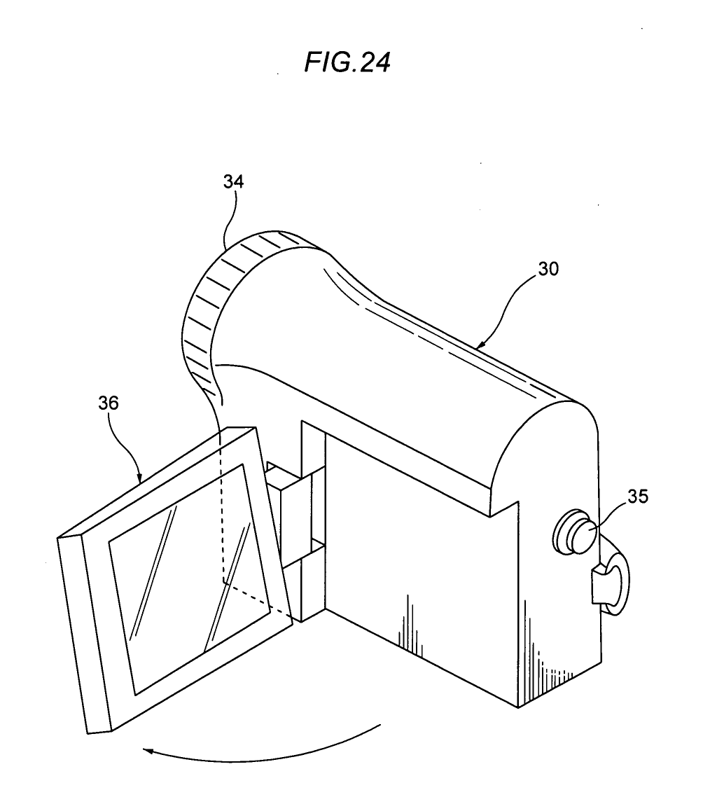

FIG. 24 is a diagram of an example of a video camera according to the sixth embodiment. The video camera is a video camera to which the first to fifth embodiments are applied. The video camera includes a main body 30, a subject photographing lens 34 on a front side, a start/stop switch 35 for photographing, and a monitor 36. For example, the video camera is manufactured by using the display device according to the first embodiment in the monitor 36.

The embodiments of the present invention indicate examples for embodying the present invention and respectively have correspondence relations with the claimed elements in claims. However, the present invention is not limited to the embodiments. Various modifications can be applied to the present invention without departing from the spirit of the present invention.

The present application contains subject matter related to that disclosed in Japanese Priority Patent Application JP 2009-157419 filed in the Japan Patent Office on Jul. 2, 2009, the entire contents of which is hereby incorporated by reference.

What is claimed is:

1. A display device comprising:
plural pixel circuits; and
a scanning circuit that supplies a scanning signal for supplying a video signal including information of a display target video to the plural pixel circuits and transitions potential of the scanning signal to off-potential halfway in a mobility correction period for correcting mobility, wherein
each of the plural pixel circuits includes
a storage capacitor for storing voltage equivalent to the video signal,
a writing transistor that writes the video signal in the storage capacitor on the basis of the scanning signal and changes to a non-conduction state when the off-potential of the scanning signal is supplied,
a driving transistor that outputs electric current corresponding to the voltage equivalent to the video signal written in the storage capacitor, and
a light emitting element that emits light according to the electric current output from the driving transistor.

2. A display device according to claim 1, wherein the scanning circuit starts, when the off-potential is supplied halfway in the mobility correction period, the supply of the off-potential at timing when the voltage written in the storage capacitor is substantially maximized in the mobility correction period.

3. A display device according to claim 1, further comprising a power supply circuit that supplies, when the off-potential is supplied halfway in the mobility correction period, potential that is high compared with potential during the start of the mobility correction period as power supply potential for the driving transistor.

4. A display device according to claim 1, wherein the scanning circuit supplies, when the supply of the off-potential of the scanning signal is started halfway in the mobility correction period, the scanning signal having a falling characteristic that is gentle compared with a rising characteristic of the scanning signal during the start of the mobility correction period.

5. A display device according to claim 1, wherein the scanning circuit supplies, when the off-potential is supplied halfway in the mobility correction period, potential that is high compared with potential supplied when the light emitting element is caused to emit light.

6. An electronic apparatus comprising:
plural pixel circuits; and
a scanning circuit that supplies a scanning signal for supplying a video signal including information of a display target video to the plural pixel circuits and transitions potential of the scanning signal to off-potential halfway in a mobility correction period for correcting mobility, wherein
each of the plural pixel circuits includes
a storage capacitor for storing voltage equivalent to the video signal,
a writing transistor that writes the video signal in the storage capacitor on the basis of the scanning signal and changes to a non-conduction state when the off-potential of the scanning signal is supplied,
a driving transistor that outputs electric current corresponding to the voltage equivalent to the video signal written in the storage capacitor, and
a light emitting element that emits light according to the electric current output from the driving transistor.
